(19) United States
(12) Patent Application Publication
(10) Pub. No.: US 2026/0289258 A1
(43) Pub. Date: Sep. 24, 2026

(54) SYSTEM

(71) Applicant: SoftBank Group Corp., Tokyo (JP)

(72) Inventor: Takehiro YANO, Tokyo (JP)

(73) Assignee: SoftBank Group Corp., Tokyo (JP)

(21) Appl. No.: 19/564,261

(22) Filed: Mar. 12, 2026

(30) Foreign Application Priority Data
Mar. 19, 2025 (JP) 2025-044908

(51) Int. Cl. G06N 3/0475; G06F 9/50

(52) U.S. Cl. CPC G06N 3/0475; G06F 9/5033

(57) ABSTRACT

A system includes a processor that is configured to provide an interface for receiving input information from a user, analyze the received input information and generate a prompt for instructing a generative AI model to generate an optimal travel plan, and input the generated prompt into the generative AI model to cause the generative AI model to generate the optimal travel plan.

### CROSS-REFERENCE TO RELATED APPLICATION

This application is based on and claims priority under 35 USC 119 from Japanese Patent Application No. 2025-044908 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional travel planning systems generally require a user to manually search for transportation options, accommodations, and sightseeing spots using multiple tools and services, and then manually combine the obtained information into a consistent itinerary. Such manual operations are time-consuming and burdensome for the user, and make it difficult to generate an optimal travel plan that balances constraints such as budget, travel period, and user preferences. Furthermore, even when a travel plan is generated, the user often needs to perform separate reservation procedures for each of transportation, accommodations, and sightseeing facilities on different reservation sites or systems, which complicates the overall process and increases the risk of input mistakes and inconsistencies between the plan and actual reservations. In addition, existing systems that use generative AI models for travel planning typically do not provide a unified mechanism for transforming user input into appropriate prompts, for presenting the generated travel plan in a user-friendly format such as a digital tour pamphlet, and for performing batch reservations based on the generated plan. Therefore, there is a need for a system that can automatically convert user input into a suitable prompt for a generative AI model, obtain an optimal travel plan from the generative AI model, present the travel plan in an intuitive digital tour pamphlet format, and further perform batch reservations for transportation, accommodations, and sightseeing spots in accordance with the presented travel plan.

### SUMMARY

In order to solve the above-described problems, according to one aspect of the present invention, there is provided a system comprising a processor, wherein the processor is configured to provide an interface for receiving input information from a user, such as a travel destination, travel period, budget, and user preferences. The processor is further configured to analyze the received input information and generate a prompt for instructing a generative AI model to generate an optimal travel plan. The processor is configured to input the generated prompt into the generative AI model to cause the generative AI model to generate the optimal travel plan based on the user's conditions. The processor is also configured to perform display processing to provide the generated optimal travel plan to the user in a digital tour pamphlet format, for example by presenting, on a display device, an itinerary, summary information, maps, and related content in an integrated and visually understandable manner. Moreover, the processor is configured to perform batch reservation processing for an itinerary, transportation, accommodations, and sightseeing spots of a trip based on the provided digital tour pamphlet, such that the processor can, through cooperation with external reservation systems or internal reservation modules, execute a series of reservation procedures in an integrated manner. By these means, the system automatically converts the user's input into a suitable prompt for a generative AI model, obtains and presents an optimal travel plan in a digital tour pamphlet format, and performs batch reservations consistent with the generated travel plan, thereby significantly reducing the user's operational burden and improving the convenience and reliability of travel planning and reservation.

The term “system” refers to a combination of hardware and software components, including at least one processor and associated memory and interfaces, configured to execute the processing described in the present specification and claims.

The term “processor” refers to one or more hardware processing units, such as a central processing unit (CPU), graphics processing unit (GPU), microcontroller, or dedicated integrated circuit, capable of executing instructions to perform the functions specified in the present specification and claims.

The term “interface” refers to a hardware and/or software component that enables exchange of information between the system and a user, including, for example, a graphical user interface, command line interface, web interface, or application programming interface, through which the user can input information and receive output.

The term “input information” refers to data provided by a user through the interface, including at least travel-related conditions such as a travel destination, origin, travel period, budget, number of travelers, and user preferences regarding transportation, accommodations, or sightseeing.

The term “analyze” refers to processing operations performed by the processor on input information, including parsing, validating, classifying, transforming, or extracting relevant parameters so as to prepare such information for use in generating a prompt for a generative AI model.

The term “prompt” refers to a structured text or data sequence generated by the processor based on the analyzed input information and designed to be supplied as input to a generative AI model to cause the generative AI model to output an optimal travel plan.

The term “generative AI model” refers to a machine learning model, such as a large language model, generative neural network, or other generative artificial intelligence model, configured to receive a prompt as input and generate a corresponding output, including at least a travel plan in natural language, structured data, or a combination thereof.

The term “optimal travel plan” refers to a travel schedule or itinerary generated using the generative AI model and prepared based on the user's input information, which includes at least information on travel dates, transportation options, accommodations, and optionally sightseeing spots, and which is optimized according to one or more criteria such as budget, time efficiency, convenience, or user preferences.

The term “display processing” refers to processing performed by the processor to generate display data, such as screen layouts, graphical elements, and formatted text, for presentation of information, including the optimal travel plan, on a display device associated with the system or client terminal.

The term “digital tour pamphlet format” refers to a display format in which the optimal travel plan is presented in an integrated, tour-pamphlet-like layout, including at least an itinerary, summary information, and optionally maps, images, and interactive controls, in a form that enables a user to intuitively understand the overall travel plan.

The term “batch reservation processing” refers to processing by which the processor performs, in an integrated and coordinated manner, a plurality of reservation operations relating to a travel plan, including at least reservations for transportation, accommodations, and sightseeing spots, based on information contained in the digital tour pamphlet.

The term “itinerary” refers to a structured schedule of a trip, including at least dates or times and associated activities, such as departures, arrivals, check-ins, check-outs, and visits to sightseeing spots, derived from or included in the optimal travel plan.

The term “transportation” refers to travel means used to move a user between locations during a trip, including, for example, trains, buses, airplanes, ships, taxis, or ride-sharing services, together with associated schedule and fare information.

The term “accommodations” refers to lodging facilities used during a trip, including, for example, hotels, inns, hostels, guest houses, or other types of facilities where a user can stay overnight, together with associated reservation conditions.

The term “sightseeing spots” refers to locations or facilities that a user may visit during a trip for tourism or leisure purposes, including, for example, historical sites, temples, shrines, museums, parks, tourist attractions, or event venues, together with associated details such as opening hours and entrance fees.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

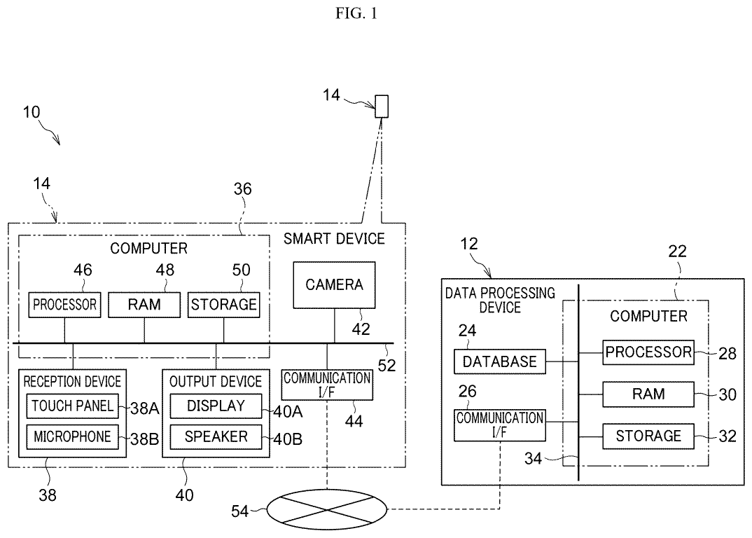

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

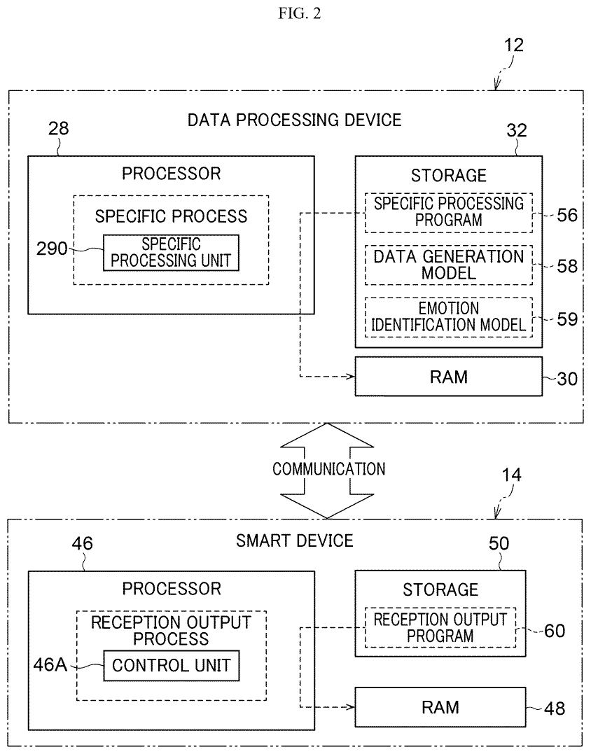

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples.

Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented travel planning systems mainly rely on fixed rule engines, static templates, or simple search aggregation that combine pre-defined travel products. Such systems typically accept destination, period, and budget as inputs, but the server-side processing is limited to keyword-based retrieval and straightforward filtering. As a result, the generated plans are often generic, poorly aligned with nuanced user constraints, and not optimized in view of current trends or cost structures. Furthermore, the internal computation is not structured to take full advantage of generative AI models or to robustly handle their outputs at the system level.

In particular, there are several technical problems from the viewpoint of computer technology. First, server-side components generally do not decompose user input, historical data, and trend data into a machine-oriented representation that is suitable for constructing high-quality prompt sentences for a generative AI model. Without a structured prompt-generation pipeline, the generative AI model tends to produce unstable, inconsistent, or unstructured output, increasing the burden on downstream processing and degrading system reliability.

Second, existing systems lack a dedicated verification and normalization stage that programmatically checks and corrects generative AI model outputs against system-level constraints, such as an upper expenditure limit or a specified implementation period. In many cases, the server simply passes generated content directly to the client, without verifying temporal consistency, budget adherence, or structural completeness. This leads to invalid itineraries, inconsistent costs, and data structures that are difficult for other server modules to consume, which in turn reduces system robustness and prevents safe automation of downstream reservation processing.

Third, there is insufficient integration between generative AI-based plan generation and the structured generation of digital guide information that can be efficiently rendered on heterogeneous terminal devices. Existing systems do not clearly define a server-side transformation pipeline that converts behavior plan data into structured, layout-aware electronic guide information, such as a digital tour brochure, in a form that is both machine-parseable and visually optimized for presentation on general-purpose terminals. This results in additional client-side complexity, redundant data transformations, and inefficiencies in rendering workflows.

Fourth, conventional architectures typically treat reservation processing as a loosely coupled, manual step following plan review, without tightly coupling generative AI outputs and batch reservation transactions. There is no unified server-side mechanism to automatically transform AI-generated behavior plan data into normalized external reservation requests, to coordinate communication with multiple external reservation devices, and to aggregate confirmation information in a transactionally consistent manner. This causes fragmentation of processes, increased error rates in reservation execution, and difficulty in scaling the system to large numbers of users and external reservation endpoints.

Therefore, there is a need for an improved computer-implemented system and server-side processing architecture that (i) systematically constructs and inputs prompt sentences for a generative AI model based on structured input and reference information, (ii) programmatically verifies and normalizes AI-generated behavior plan data against temporal and budget constraints, (iii) transforms the verified plan into structured digital guide information tailored for electronic presentation, and (iv) automatically executes and aggregates batch reservation processes in a consistent and machine-controlled manner. Such a system would improve the technical functioning of the server and its cooperation with terminal devices, enhance reliability and consistency of AI-assisted planning, and reduce the computational and operational overhead required to manage complex travel planning workflows.

The specific processing by the specific processing unit 290 of the data processing device 12 in Example 1 is realized by the following means.

The present invention provides a server comprising a processor configured to acquire, via an information acquisition unit, input information from a user including at least a target region, an implementation period, and an upper expenditure limit; to obtain, from an information storage unit, reference information including past information and trend information related to the target region; to generate, via a prompt generation unit, a prompt sentence for a generative information processing model by combining the input information with the reference information in a structured manner; to input the generated prompt sentence into the generative information processing model and, via a behavior plan generation unit, cause the generative information processing model to generate behavior plan data including activity elements, movement means, staying facilities, and cost information that conform to the implementation period and the upper expenditure limit; to analyze the generated behavior plan data and, via a plan verification unit, verify structural completeness and consistency of the behavior plan data, including verification of the cost information relative to the upper expenditure limit and temporal consistency of the activity elements and movement means relative to the implementation period, and to normalize the behavior plan data when necessary; to convert, via a guide information generation unit, the verified behavior plan data into guide information for an electronic medium, the guide information including time-series information, position information, cost information, and visual configuration information in a structured format suitable for rendering; to transmit, via a guide information providing unit, the guide information for the electronic medium as display image data or structured data to a terminal device in a digital tour brochure format; and to execute, via a reservation processing unit and through communication with a plurality of external reservation devices, a batch of reservation processes corresponding to at least a schedule, movement means, and staying facilities indicated by a behavior plan selected by the user on the basis of the guide information, and to integrate reservation results obtained from the external reservation devices into reservation confirmation information including reservation identification information and total cost information. This enables the server to implement an integrated, machine-controlled pipeline that (i) constructs optimized prompt sentences for a generative AI model from structured user and reference data, (ii) automatically verifies and normalizes AI-generated behavior plan data against budgetary and temporal constraints, (iii) generates structured digital guide information that can be efficiently rendered by terminal devices, and (iv) reliably executes and aggregates batch reservations across multiple external reservation systems, thereby improving the technical performance, robustness, and scalability of computer-based travel planning and reservation processing.

The term “input information” refers to information received from a user via an input interface, including at least a target region, an implementation period, and an upper expenditure limit, and optionally additional constraints such as user preferences, required activities, or exclusion conditions, which is used as a basis for generating a behavior plan.

The term “target region” refers to a geographical area, such as a city, region, or country, that serves as a primary location or destination for which a behavior plan is to be generated.

The term “implementation period” refers to a time duration during which the behavior plan is intended to be executed, the duration including at least a start time or date and an end time or date.

The term “upper expenditure limit” refers to a maximum allowable total cost specified by the user or predetermined by the system, which constrains the aggregate costs in the behavior plan.

The term “information acquisition unit” refers to a functional component implemented by hardware, software, or a combination thereof, that is configured to receive input information from a user through an interface such as a graphical user interface, an application programming interface, or a communication interface.

The term “information storage unit” refers to a functional component implemented by hardware, software, or a combination thereof, that stores data including past information and trend information, and that can be queried or accessed by the processor when generating or refining behavior plan data.

The term “past information” refers to previously collected data related to activities, movement means, staying facilities, costs, or user behavior, including but not limited to historical bookings, past ratings, and historical price information.

The term “trend information” refers to data representing current or recent tendencies or patterns, including but not limited to seasonal demand, popularity scores, dynamic pricing information, and frequently selected activities or facilities for a given target region.

The term “generative information processing model” refers to a machine-learned model, such as a generative AI model based on a neural network architecture, that generates output data including text or structured data in response to an input prompt sentence.

The term “prompt sentence” refers to a machine-readable instruction sequence, typically in natural language and optionally including structured tokens, that is generated based on input information and reference information and is supplied to the generative information processing model to control the content and structure of the model's output.

The term “prompt generation unit” refers to a functional component implemented by hardware, software, or a combination thereof, that is configured to construct a prompt sentence for a generative information processing model by combining and formatting input information and reference information.

The term “behavior plan data” refers to structured data representing a proposed plan for activities over the implementation period, including at least activity elements, movement means, staying facilities, and associated cost information, which is generated by the generative information processing model in response to a prompt sentence.

The term “activity element” refers to a unit of planned action within a behavior plan, including but not limited to visiting a location, participating in an event, or performing a task, and associated metadata such as time, location, and cost.

The term “movement means” refers to a method or mode of transportation, including but not limited to walking, public transportation, private vehicles, or other transit options used to move between locations in the behavior plan.

The term “staying facility” refers to a place of accommodation or temporary stay, including but not limited to hotels, inns, guest houses, or other lodging facilities, that can be reserved as part of the behavior plan.

The term “cost information” refers to data indicating monetary amounts associated with activity elements, movement means, and staying facilities, including per-item costs, aggregated costs, and a total estimated cost for the behavior plan.

The term “behavior plan generation unit” refers to a functional component implemented by hardware, software, or a combination thereof, that supplies a prompt sentence to a generative information processing model and receives and outputs behavior plan data generated by the model.

The term “plan verification unit” refers to a functional component implemented by hardware, software, or a combination thereof, that analyzes behavior plan data to verify structural completeness and to evaluate consistency between cost information and the upper expenditure limit, as well as temporal consistency between planned activities, movement means, and the implementation period.

The term “normalize the behavior plan data” refers to adjusting, correcting, or reformatting behavior plan data to conform to predetermined constraints, schemas, or formats, including resolving minor inconsistencies, standardizing units, and reconciling cost or time discrepancies.

The term “guide information for an electronic medium” refers to structured information that is derived from behavior plan data and that is formatted for display or rendering on an electronic device, including time-series information, position information, cost information, and visual configuration information.

The term “time-series information” refers to data representing temporal ordering and timing of activity elements and movement means, including start times, end times, and chronological relationships between items in a behavior plan.

The term “position information” refers to data indicating spatial locations related to activity elements, movement means, or staying facilities, including but not limited to address information, geographic coordinates, or location identifiers.

The term “visual configuration information” refers to layout-related data specifying how elements of guide information for an electronic medium are to be visually arranged, grouped, or emphasized when rendered on a display, including but not limited to section structures, ordering, labels, and style attributes.

The term “guide information generation unit” refers to a functional component implemented by hardware, software, or a combination thereof, that converts verified behavior plan data into guide information for an electronic medium, including layout-aware and structure-aware data suitable for rendering.

The term “guide information providing unit” refers to a functional component implemented by hardware, software, or a combination thereof, that transmits guide information for an electronic medium to a terminal device in the form of display image data or structured data.

The term “digital tour brochure format” refers to a structured representation of guide information for an electronic medium that emulates a tour brochure, including sections such as daily or time-zone-based activity lists, descriptions of staying facilities, transportation information, and cost breakdowns, arranged in a visually organized form suitable for electronic display.

The term “terminal device” refers to a computing device operated by a user, including but not limited to a smartphone, tablet, personal computer, or other display-equipped device capable of receiving and presenting guide information for an electronic medium.

The term “reservation processing unit” refers to a functional component implemented by hardware, software, or a combination thereof, that executes reservation processes in association with external reservation devices based on behavior plan data or a user-selected behavior plan.

The term “external reservation device” refers to a server, system, or service accessible over a communication network that is configured to process reservation requests for at least schedules, movement means, or staying facilities and to return reservation results.

The term “batch of reservation processes” refers to a group of multiple reservation operations, including reservations for a schedule, movement means, and staying facilities, executed in a coordinated manner in response to a single user selection or behavior plan.

The term “reservation result” refers to data returned from an external reservation device in response to a reservation request, including information such as reservation status, assigned resources, and individual costs.

The term “reservation confirmation information” refers to aggregated information generated from multiple reservation results, including at least reservation identification information and total cost information, that can be provided to a user as a final confirmation of completed reservations.

The term “reservation identification information” refers to identifiers associated with one or more reservations, including but not limited to booking numbers, confirmation codes, or transaction identifiers.

The term “total cost information” refers to data indicating an aggregate monetary amount resulting from one or more reservations included in a batch of reservation processes.

In one embodiment, a server cooperates with at least one terminal and at least one user to implement the claimed system. The server includes at least one processor, a main memory, a non-volatile storage device, a network interface, and, optionally, one or more hardware accelerators such as a graphics processing unit. The terminal includes at least one processor, a display device, an input device such as a touch panel or keyboard, and a communication interface. The user operates the terminal to provide input information and to receive guide information and reservation confirmation information.

The server executes an operating system such as a general-purpose server operating system and executes application software including a web application framework, an application programming interface layer, a database management system, and a generative AI client library. The server uses, for example, a web server and an application framework such as a scripting environment or an object-oriented framework to implement an application that provides an input interface, constructs a prompt sentence for a generative AI model, processes an output from the generative AI model, generates guide information for an electronic medium, and performs reservation processing in cooperation with external reservation devices.

The server stores, in the non-volatile storage device, program modules such as an information acquisition unit, a prompt generation unit, a behavior plan generation unit, a plan verification unit, a guide information generation unit, a guide information providing unit, and a reservation processing unit. The server also stores an information storage unit implemented as one or more databases, for example a relational database management system, that holds past information and trend information, including historical reservations, historical prices, user rating statistics, popularity indices, seasonal coefficients, and typical cost distributions for activities, movement means, and staying facilities.

The terminal executes a browser or a native application that communicates with the server via a network using a communication protocol such as HTTPS. The terminal renders visual components based on display image data or structured data provided by the server. The user uses the terminal to input a target region, an implementation period, an upper expenditure limit, and optionally preference data such as desired categories of activities, maximum number of movements per day, or preferred types of staying facilities.

The server, through the information acquisition unit, receives the input information transmitted from the terminal. The information acquisition unit is implemented, for example, as an application-layer interface that accepts network requests using a web framework. The server maps this input information into internal data structures, such as objects or records that represent a target region, an implementation period described in start and end timestamps normalized to a standard time zone, and an upper expenditure limit stored as a numeric value in a base currency.

The server, through the information storage unit, retrieves past information and trend information corresponding to the target region. The information storage unit maintains normalized tables for activities, movement means, staying facilities, and cost statistics. The server performs structured queries to retrieve, for example, a list of candidate activities with attributes such as location coordinates, typical duration, average satisfaction score, and average cost; a list of candidate transport segments with attributes such as origin and destination coordinates, travel time, schedule patterns, and average fare; and a list of candidate staying facilities with attributes such as location coordinates, capacity, rating distributions, and price distributions. The server computes aggregated trend features such as season-adjusted cost multipliers and popularity scores by applying statistical operations and weighting functions on historical data. These computations use standard numerical libraries and database functions, which improve the data quality and reduce noise before the data is forwarded to downstream modules.

The server, through the prompt generation unit, constructs a prompt sentence for a generative AI model. The prompt generation unit uses a deterministic string-building algorithm that maps the structured input information and reference information into a machine-optimized textual structure. The server divides the prompt into sections, such as an instruction section, a constraint section, and an output-format section, and concatenates these sections in a controlled order. The server also embeds explicit constraints as textual tokens, such as “do not exceed total cost of [value]” and “fit all activities into [number] days,” and includes, in compact form, summary statistics derived from the information storage unit, such as “typical meal cost range” or “typical lodging cost range.” By structuring the prompt in this manner, the server reduces ambiguity and stabilizes the output structure of the generative AI model, improving parseability and reducing the likelihood of malformed or unusable responses.

In one example, the server constructs the following prompt sentence and transmits it to the generative AI model:
“You are a professional travel planner. Using the following conditions, generate an optimal travel itinerary.
Destination: Kyoto
Duration: 2 days
Total budget: 30,000 yen
Use current price levels and typical costs in the destination region.

### Requirements:

1. Include morning, afternoon, and evening activities for each day.
2. Recommend specific tourist spots, accommodations within budget, and transportation options.
3. Estimate costs for each item and ensure the total estimated cost stays within 30,000 yen.
4. Output the result as structured data with the following sections: day_plans, accommodations, transportation, and total_estimated_cost.

Ensure that all activities fit within the specified duration and that travel times between locations are realistic.”

The server communicates this prompt sentence to a generative AI model. In one embodiment, the generative AI model is a neural network-based language model, such as a transformer architecture that includes a stack of multi-head self-attention layers, feed-forward layers, layer normalization layers, and positional encoding. The server stores or accesses model parameters, such as weight matrices and bias vectors, that have been learned in advance using supervised learning and reinforcement learning on large corpora of text and structured itineraries. The model processes tokenized representations of the prompt sentence. The server uses a tokenizer that maps text to token identifiers, and then supplies token sequences, along with positional indices and, optionally, segment identifiers, to the generative AI model. The model computes, for each layer, attention scores based on similarity metrics such as scaled dot-products between query vectors and key vectors, applies softmax functions to obtain attention distributions, and computes weighted sums of value vectors. The model applies non-linear activation functions in feed-forward sublayers and propagates intermediate representations through the network until an output sequence of token probability distributions is generated.

The server controls generation parameters such as a temperature parameter, a maximum number of tokens, and a top-k or top-p sampling parameter, so that the output balances variability and constraint satisfaction. By tuning these parameters, the server reduces the probability of producing outputs that violate budget or temporal constraints and improves the repeatability of behavior plan data generation.

The server, through the behavior plan generation unit, decodes the output token stream produced by the generative AI model into text and then parses the text into behavior plan data. The behavior plan data is marshaled into a formal data model that includes at least activity elements, movement means, staying facilities, and cost information. The server enforces a schema that defines, for each activity element, required fields such as a time slot identifier, a location identifier, a description, an estimated duration, and an estimated cost; and, for each movement means, fields such as departure time, arrival time, origin coordinates, destination coordinates, and a fare; and, for each staying facility, fields such as check-in time, check-out time, nightly rate, and total lodging cost.

The server, through the plan verification unit, executes multiple validation and normalization procedures. The server computes the sum of the itemized cost information, and compares the computed total with the upper expenditure limit. If the total exceeds the upper expenditure limit by more than a tolerance threshold, the server marks the behavior plan data as inconsistent and may either adjust the cost allocation using a predetermined rule set or request regeneration by modifying the prompt sentence. The server also maps activity times, movement times, and lodging intervals onto a unified timeline represented as a sequence of time slots for the implementation period. The server detects temporal conflicts such as overlapping activities or insufficient transfer times between locations. If conflicts are detected, the server resolves them by applying adjustment rules, for example shifting lower-priority activities or reassigning movement means, while maintaining key constraints such as arrival and departure times.

The server normalizes location identifiers using geocoding functions. The server maps textual location names into coordinate pairs stored in the information storage unit and uses distance calculations to verify that movement durations proposed in the behavior plan data are physically plausible given typical movement means. This verification step uses distance formulas and average speed models to compute expected travel times and compares them to travel times indicated in the behavior plan data. By applying these checks, the server reduces the likelihood of generating itineraries that cannot be executed in reality, thereby improving the technical reliability of the system.

The server, through the guide information generation unit, converts the verified behavior plan data into guide information for an electronic medium. The guide information generation unit applies layout rules that map activity elements, movement means, and staying facilities into a multi-level structure that describes pages, sections, items, and visual emphasis attributes. For example, the server assigns each day of the implementation period to a “day section,” orders the activity elements within each day section according to start time, and associates movement means with transitions between activity elements. The server generates metadata for display, such as color codes for different categories of activities, icons representing movement means, and grouping labels for cost breakdowns. The server also embeds time-series information, such as a sequence of contiguous time blocks, and position information, such as location coordinates or map links, into the guide information. By generating such structured guide information, the server allows terminal devices with different display capabilities to render a consistent digital tour brochure layout with minimal client-side computation.

The server, through the guide information providing unit, transmits the guide information for the electronic medium to the terminal. The server can provide the guide information either as directly renderable markup or as structured data that is interpreted by a client-side program.

The terminal receives the guide information, maps it to local display components, and renders the digital tour brochure using its graphics subsystem. The user views the itinerary, examines cost breakdowns and time allocations, and selects a desired behavior plan or modifies options where the implementation permits.

The server, through the reservation processing unit, converts the selected behavior plan data into a series of reservation requests for external reservation devices. The server uses a mapping table that associates internal representations of staying facilities and movement means with external service identifiers. For each activity that requires reservation and each staying facility and movement means, the server generates external reservation device request data including structured fields such as check-in/check-out dates, passenger counts, seat classes, and payment parameters. The server then transmits these requests over a communication network using communication protocols defined by the external reservation devices. The reservation processing unit may employ a transactional controller that groups reservation requests into logical units of work. The server records reservation responses including reservation identifiers and status codes, and aggregates them into reservation confirmation information. The server sends this reservation confirmation information to the terminal via the guide information providing unit, so that the terminal can display a consolidated confirmation view.

The system, in this configuration, improves computer technology in several ways. The server reduces processing load and parsing errors by generating, in a structured manner, the prompt sentence that is used to drive the generative AI model. By embedding explicit constraints and statistical reference values into the prompt sentence, the server improves the alignment between the model output structure and the internal behavior plan data schema, which reduces post-processing overhead and increases accuracy of schedule and cost estimation.

This improvement exceeds mere automation of human planning, because the server defines a machine-optimized interaction protocol between deterministic components and a generative AI model that is not achievable by simple manual operations.

The server also improves resource utilization and latency by implementing the plan verification unit and the guide information generation unit as modular processing stages.

These stages operate on standardized data structures, enabling efficient in-memory data transformations, cache reuse for frequently used reference data, and early detection of invalid plans. Because the server corrects or rejects inconsistent plans before generating guide information or initiating reservations, the number of unnecessary external API calls and related network traffic is reduced, which lowers communication load and improves overall system responsiveness.

In another embodiment, the server stores training data and learning configurations for the generative AI model. The server may perform additional fine-tuning of the model using supervised learning on curated travel-plan data. The server computes a loss function such as a cross-entropy loss between predicted token probabilities and ground-truth tokens in example itineraries. The server uses an optimization algorithm, such as a gradient-based method, to update the weights of the neural network, applying techniques such as learning rate scheduling, gradient clipping, and regularization. The server may perform data augmentation by, for example, generating paraphrased prompt sentences, varying budget constraints, and modifying implementation periods, to increase the robustness of the model across different conditions. By integrating this learning process with system requirements, the server improves prediction accuracy specifically for travel planning tasks and enhances the consistency between generated behavior plan data and the system's structural schema.

The system can be implemented in different variations. In one variation, the generative AI model is hosted externally and accessed via a network by the server, and the server focuses on prompt optimization, schema validation, and integration with databases and external reservation devices. In another variation, the generative AI model is deployed locally on a high-performance computing node including at least one graphics processing unit, and the server executes the model inference directly. In this case, the server can adjust low-level inference parameters, such as batch sizes, precision modes, and model partitioning strategies, to balance throughput and latency.

In another embodiment, the server partitions the guide information generation unit into a server-side layout generator and a terminal-specific adaptor module. The server prepares device-agnostic layout descriptors, and the terminal's client application maps these descriptors to device-specific UI components. This separation allows the server to reuse guide information for terminals with different display resolutions and aspect ratios, reducing redundant computation and improving scalability.

In yet another embodiment, the server implements deterministic fallback rules to handle cases where the generative AI model output is incomplete or partially inconsistent. The server may, for example, fill missing cost information using reference cost averages from the information storage unit, or replace an impossible movement means with a feasible alternative determined by a shortest-path or constrained-routing algorithm. These rules, and the generative AI model outputs, jointly produce behavior plan data that is more robust than either approach alone.

Because the server structurally fuses deterministic algorithms with generative outputs, the overall system achieves improved accuracy and consistency while maintaining flexibility.

Through these configurations, the server, terminal, and user cooperate to realize a system in which a generative AI model is not used as a black-box content generator but as an integrated computational component governed by explicit prompt sentences, structural schemas, verification algorithms, and reservation control logic. This integration improves calculation efficiency, enhances data management, reduces communication overhead, and provides a technically improved computer-based travel planning and reservation system that goes beyond mere automation of human tasks.

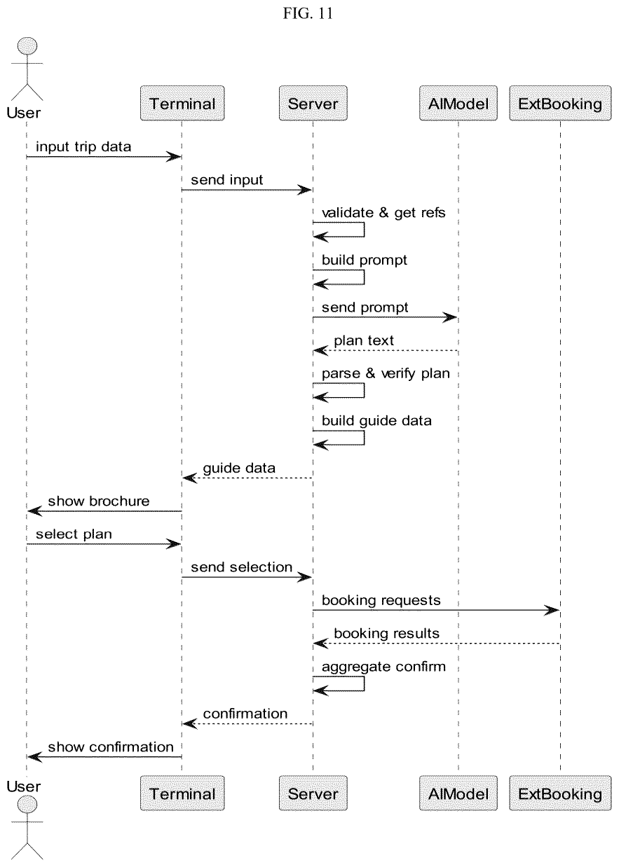

The following describes the processing flow using FIG. 11.

### Step 1:

User operates the terminal to open an input interface provided by the server and enters input information.

User specifies a target region, an implementation period, and an upper expenditure limit, and optionally preference information such as desired activity types or lodging classes.

Input: User's raw textual inputs (e.g., “Kyoto”, “2 days”, “30,000 yen”) and selections on the terminal UI.

Output: Structured input information displayed on the terminal and prepared for transmission (e.g., destination string, normalized dates, numeric budget).

### Step 2:

Terminal collects the structured input information and transmits it to the server via a network.

Terminal converts the user inputs into a structured request, for example, by mapping dates to ISO-formatted strings and budgets to an integer value, and sends the request to an endpoint on the server using a secure protocol.

Input: User-edited values in UI components (text fields, date pickers, numeric fields).

Output: A network request message containing structured input information addressed to the server.

### Step 3:

Server receives the network request and validates the input information.

Server parses the request, checks that required fields (target region, implementation period, upper expenditure limit) are present, verifies that the implementation period is valid (end date after start date), and that the upper expenditure limit is a positive number within a preconfigured range.

Input: Structured input information contained in the request message.

Output: Validated input information, or an error response message if validation fails.

### Step 4:

Server retrieves reference information from the information storage unit based on the validated input information.

Server queries internal databases for past information (historical reservations, average costs, user ratings) and trend information (seasonal popularity, current price multipliers) corresponding to the target region and implementation period, and aggregates the retrieved records.

Input: Validated input information including target region and implementation period.

Output: Reference information containing lists of candidate activities, movement means, staying facilities, and associated statistical features.

### Step 5:

Server generates a prompt sentence for a generative AI model using the prompt generation unit.

Server maps the validated input information and the reference information into a structured text format, divides the text into instruction, constraint, and output-format sections, and concatenates them to form a single prompt sentence that clearly encodes constraints on budget, time, and structure of the desired output.

Input: Validated input information and aggregated reference information.

Output: A prompt sentence prepared for submission to the generative AI model.

### Step 6:

Server transmits the prompt sentence to the generative AI model and obtains generated text representing a behavior plan.

Server tokenizes the prompt sentence, calls a generative AI model endpoint or local inference engine with control parameters (e.g., temperature, maximum token count), and receives a generated text response that describes activities, movement means, staying facilities, and estimated costs.

Input: Prompt sentence and generation control parameters.

Output: Generated text output from the generative AI model representing a preliminary behavior plan.

### Step 7:

Server parses the generated text and constructs behavior plan data.

Server identifies key sections (for example, day-wise activities, accommodations, transportation, total cost) in the generated text, extracts items using pattern matching or schema-guided parsing, and converts them into structured data records.

Input: Generated text output from the generative AI model.

Output: Behavior plan data including structured activity elements, movement means, staying facilities, and cost information.

### Step 8:

Server verifies and normalizes the behavior plan data using the plan verification unit.

Server sums itemized costs and compares the total against the upper expenditure limit, checks that activity times and movement intervals fit within the implementation period, detects overlaps and impossible travel times using distance and time calculations, and corrects or flags inconsistencies according to predefined adjustment rules.

Input: Behavior plan data and validated input information (implementation period and upper expenditure limit).

Output: Verified and, if necessary, normalized behavior plan data that is consistent with budget and time constraints.

### Step 9:

Server generates guide information for an electronic medium using the guide information generation unit.

Server maps the verified behavior plan data onto a layout structure with day sections, time-ordered activities, associated movement segments, lodging details, and cost breakdowns, and adds visual configuration metadata such as icons, color codes, and grouping labels for later rendering.

Input: Verified and normalized behavior plan data.

Output: Guide information for an electronic medium, including time-series information, position information, cost information, and visual configuration information.

### Step 10:

Server provides the guide information to the terminal via the guide information providing unit.

Server encapsulates the guide information in a format suitable for transmission (e.g., structured data or display-ready markup) and sends it to the terminal over the network, optionally compressing the data to reduce communication load.

Input: Guide information for an electronic medium.

Output: Response message containing guide information addressed to the terminal.

### Step 11:

Terminal receives the guide information and renders a digital tour brochure for the user.

Terminal parses the received guide information, maps layout descriptors to terminal-specific UI components such as lists, cards, and timelines, and draws text, icons, and images on the display so that the user can visually inspect daily schedules, places, routes, and costs.

Input: Guide information for an electronic medium received from the server.

Output: Visual digital tour brochure presented on the terminal display.

### Step 12:

User reviews the digital tour brochure and selects a desired behavior plan or plan options.

User examines activities, lodgings, and transportation details and interacts with the terminal UI (for example, selecting a specific lodging option or confirming the whole itinerary) to indicate a final choice.

Input: Visual information from the digital tour brochure.

Output: User selection data captured by the terminal (e.g., identifiers of selected activities, movement means, and staying facilities).

### Step 13:

Terminal transmits the user selection data to the server.

Terminal converts the selected behavior plan elements into a structured selection message and sends the message over the network to a reservation endpoint on the server.

Input: User selection data obtained from UI operations.

Output: Network request message containing selection data addressed to the server.

### Step 14:

Server performs batch reservation processing using the reservation processing unit.

Server maps internal identifiers for selected movement means and staying facilities to external reservation device identifiers, generates reservation requests with necessary parameters (dates, times, quantities, categories), sends these requests to multiple external reservation devices, and collects the corresponding reservation results.

Input: User selection data and mapping information between internal entities and external reservation devices.

Output: A set of reservation results received from external reservation devices, each including a reservation status and identification data.

### Step 15:

Server aggregates reservation results and generates reservation confirmation information.

Server verifies that all required reservations succeeded, combines individual reservation identifiers and cost values into a unified confirmation structure, recalculates a total cost value, and attaches error or status codes if partial failures occur.

Input: Multiple reservation results from external reservation devices.

Output: Reservation confirmation information including reservation identification information and total cost information.

### Step 16:

Server provides the reservation confirmation information to the terminal via the guide information providing unit.

Server formats the reservation confirmation information as structured data or display-ready content, attaches any instructions or cancellation policies, and sends the formatted data to the terminal over the network.

Input: Reservation confirmation information.

Output: Response message containing reservation confirmation information addressed to the terminal.

### Step 17:

Terminal displays the reservation confirmation information to the user.

Terminal parses the confirmation information, renders a summary view showing confirmed activities, transportation segments, lodging details, reservation identifiers, and total cost, and optionally stores the confirmation in local storage so that the user can access it offline.

Input: Reservation confirmation information received from the server.

Output: Visual confirmation screen on the terminal and optionally stored confirmation data for later use.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional travel planning systems typically rely on rule-based engines or static templates that operate on limited, rigidly structured input data. Such systems often require the user to repeatedly input and refine parameters and manually reconcile output from different modules, such as itinerary generation and reservation processing. As a result, several technical problems arise in the underlying computer technology used to generate, structure, and consume complex travel-planning data.

First, there is no unified mechanism in the server to transform heterogeneous user input into a machine-interpretable instruction suitable for a generative AI model while simultaneously constraining the output into a structured format that can be directly consumed by downstream processing components. In many existing systems, a text-generating model produces free-form natural language output that must be manually reviewed or post-processed with ad hoc parsers. This leads to high CPU usage for parsing, frequent parsing failures, and non-deterministic internal data structures, thereby degrading system reliability, scalability, and response time.

Second, existing client-server travel planning architectures lack a coordinated data representation that connects an AI-generated travel plan with a digital tour pamphlet representation and subsequent bulk reservation workflows. In particular, when the AI output is not consistently structured per day or per time slot and does not include standardized identifiers, locations, and time information for activities, the server must perform multiple heuristic passes to infer schedule boundaries and activity attributes. This increases memory consumption and processing latency on the server side and complicates caching and reuse of generated plans.

Third, conventional systems provide limited support for iterative refinement of AI-generated travel plans based on user feedback. When the user attempts to modify preferences, such as preferring museums over shopping or reducing travel time, the server often regenerates the entire plan with minimal reuse of existing structured data. Because the server does not systematically encode user feedback and prior plan context into a new prompt tailored to a generative AI model, iterative refinement tends to be inefficient, generates inconsistent internal structures, and requires repeated, expensive data transformations.

Fourth, integration between AI-generated plans and bulk reservation processing is typically loosely coupled. Many systems require separate workflows for viewing an itinerary and executing reservations. The lack of a shared, hierarchically organized digital pamphlet data structure that is directly aligned with the output format of the generative AI model forces the server to perform redundant mapping and validation steps when converting between display-oriented data and reservation-oriented data. This fragmentation increases code complexity, network payload size, and error rates in inter-module communication.

Accordingly, there is a need for an improved computer-implemented system that (i) converts user input into a constrained prompt sentence for a generative AI model, (ii) enforces structured output formats at the model interface, (iii) maintains consistent internal data structures for digital tour pamphlets and reservation workflows, and (iv) supports efficient, iterative refinement of travel plans. Such a system should improve the technical performance of the server-side processing, including reductions in parsing overhead, improved determinism in internal representations, more efficient memory and CPU utilization during itinerary handling, and more robust orchestration of bulk reservation transactions.

The specific processing by the specific processing unit 290 of the data processing device 12 in Application Example 1 is realized by the following means.

The present invention provides a server comprising a processor configured to provide, on an information processing apparatus, an interface for receiving input information including travel conditions from a user; analyze the input information to normalize the travel conditions and, based on the travel conditions, generate a prompt sentence including at least items relating to a travel itinerary, a transportation resource, an accommodation resource, and a sightseeing location, and further including an output format specification, and control input of the prompt sentence to a generative AI model; acquire text or structured data of a travel plan from the generative AI model, parse the text or the structured data, convert the parsed result into an internal data structure in which the itinerary is divided on a per-day basis or a time-slot basis, and, based on the internal data structure, generate digital tour pamphlet data in which the travel itinerary, the transportation resource, the accommodation resource, and the sightseeing location are hierarchically organized; transmit the digital tour pamphlet data to a portable information terminal via a communication network, and cause the digital tour pamphlet data to be displayable by an application on the portable information terminal; receive, from the portable information terminal, a bulk reservation request for a plurality of services included in a specified travel itinerary based on the digital tour pamphlet, and, based on the bulk reservation request, execute reservation processing for a plurality of external service providing apparatuses including a transportation providing apparatus and an accommodation providing apparatus sequentially or in parallel, and generate bulk reservation result information based on results of the reservation processing; transmit the bulk reservation result information to the portable information terminal and cause finalized contents of bulk reservations to be viewable on the portable information terminal; receive, from the portable information terminal, a change request or preference information from the user with respect to the input information and the travel plan acquired from the generative AI model; generate, based on an update condition including the change request or the preference information, a new prompt sentence including an output format specification that requests that the travel itinerary be output in a structured manner and that each activity included in the travel itinerary be output in a structured data format including at least an identifier, location information, and time-slot information; input the new prompt sentence to the generative AI model to update the travel plan; and, based on structured data acquired from the generative AI model in accordance with the output format specification, regenerate the digital tour pamphlet data while maintaining the internal data structure used for display and reservation processing. This enables the server to enforce a structured interaction pattern with the generative AI model, to reduce parsing complexity and processing overhead by obtaining itinerary data in a machine-consumable format, to maintain a unified internal representation that is reusable across digital pamphlet display and bulk reservation workflows, and to perform efficient, consistent updates of travel plans in response to user feedback, thereby improving the technical performance, reliability, and scalability of the computer-implemented travel planning system.

The term “information processing apparatus” refers to a computing device, such as a server, workstation, or other electronic apparatus, that executes programs, processes data, and provides an interface for user input and communication with external devices or networks.

The term “portable information terminal” refers to a mobile computing device, such as a smartphone or tablet, that includes a display, a user input interface, and a communication function for connecting to a network and interacting with a server.

The term “application” refers to a software program executed on the portable information terminal that provides a user interface and communicates with a server to send input information, receive travel plan data, and display digital tour pamphlet data and reservation information.

The term “input information” refers to data provided by a user to the information processing apparatus or the portable information terminal, including at least travel conditions such as a travel destination, a travel period, a budget, and user preferences related to a travel plan.

The term “travel conditions” refers to constraint information and preference information used to generate a travel plan, including at least a destination, dates or a duration, a budget range, and optional user preferences such as preferred activities or transportation types.

The term “prompt sentence” refers to a text string generated by the processor that encodes the travel conditions and an output format specification as an instruction to a generative AI model for generating a travel plan.

The term “generative AI model” refers to a machine learning model, such as a neural network-based text generation model, configured to receive a prompt sentence and to output text or structured data representing a travel plan according to the instructions contained in the prompt sentence.

The term “output format specification” refers to a part of the prompt sentence that specifies structural requirements for the output of the generative AI model, including at least that the travel itinerary be organized on a per-day basis or a time-slot basis and that each activity include structured fields such as an identifier, location information, and time-slot information.

The term “travel plan” refers to data representing a proposed sequence of travel-related activities, including at least a travel itinerary, one or more transportation resources, one or more accommodation resources, and one or more sightseeing locations that satisfy the travel conditions.

The term “travel itinerary” refers to a time-ordered arrangement of travel-related activities, including movements, stays, and visits, structured on a per-day basis or a time-slot basis, and associated with corresponding locations and times.

The term “transportation resource” refers to travel-related movement information and associated services, including at least transportation modes, departure and arrival locations, times, and, optionally, identifiers of transportation service providers.

The term “accommodation resource” refers to lodging-related information and associated services, including at least lodging locations, check-in and check-out dates or times, and, optionally, identifiers of lodging service providers.

The term “sightseeing location” refers to a point of interest or facility that a user may visit during a trip, including at least a location or address and, optionally, descriptive information and recommended visiting time slots.

The term “internal data structure” refers to a machine-readable representation of a travel plan stored and processed by the server, in which elements such as days, time slots, activities, transportation resources, accommodation resources, and sightseeing locations are organized in a structured, hierarchically related format.

The term “digital tour pamphlet data” refers to display-oriented structured data generated from the internal data structure of a travel plan, the data being arranged in a hierarchical manner to represent the travel itinerary, transportation resources, accommodation resources, and sightseeing locations in a form suitable for presentation on the portable information terminal.

The term “bulk reservation request” refers to a request transmitted from the portable information terminal to the server to reserve, in a single operation, a plurality of services included in a specified travel itinerary, including at least transportation resources and accommodation resources.

The term “external service providing apparatus” refers to a system or device operated by a third-party service provider that offers reservation interfaces for travel-related services, such as transportation services, accommodation services, or activity services, and that can be accessed by the server via a communication network.

The term “transportation providing apparatus” refers to an external service providing apparatus that manages reservation processing for transportation services, including, for example, transportation schedules, seat availability, and booking confirmation.

The term “accommodation providing apparatus” refers to an external service providing apparatus that manages reservation processing for accommodation services, including, for example, room availability, lodging conditions, and booking confirmation.

The term “bulk reservation result information” refers to data generated by the server that summarizes results of reservation processing performed for a plurality of services in response to a bulk reservation request, including at least confirmation information, identifiers, and finalized contents of the reservations.

The term “change request” refers to user-specified modification information applied to an existing travel plan or to previously provided input information, including requests such as adding, removing, or replacing activities, changing budget constraints, or adjusting schedule preferences.

The term “preference information” refers to user-specific likes, dislikes, or priorities, such as preferred activity types, transportation modes, or walking distance constraints, that are used by the server to refine or update a travel plan via a new prompt sentence to the generative AI model.

The term “update condition” refers to a set of parameters used by the server to generate a new prompt sentence, the parameters including at least one of the change request and the preference information, and optionally including context from a previously generated travel plan.

In one embodiment, a server cooperates with a terminal operated by a user to implement a travel-planning system that utilizes a generative AI model while improving internal data handling, representation, and reservation orchestration in computer technology.

The server includes at least one processor, a main memory, a nonvolatile storage device, and a network interface. The server executes an operating system such as a general-purpose server operating system and middleware such as a web server and an application server framework. The server further executes an application program that implements the functions described in the claims. The server is connected via a communication network to one or more terminals and to one or more external service providing apparatuses, such as transportation providing apparatuses and accommodation providing apparatuses.

The terminal includes a processor, a memory, a display, a user input interface (for example, a touch panel), and a wireless communication module. The terminal executes an application specifically designed for travel planning. The terminal application provides a graphical user interface to the user, sends input information to the server, and receives and displays digital tour pamphlet data and reservation information.

The user operates the terminal to provide input information including travel conditions such as a destination, a travel period, a budget, and preferences. The terminal converts user operations on input fields, date pickers, selectors, and other UI components into structured data and transmits the structured data to the server over a secure communication channel.

The server stores and processes the received input information using defined data structures.

The server internally represents the travel conditions in a normalized format, for example by mapping dates into a canonical date-time representation, mapping currencies into a base currency unit, and encoding preferences into a standardized feature vector. The server uses this normalized data to construct a prompt sentence for a generative AI model.

In one example, the server generates a prompt sentence of the following form:

“Please generate a travel plan for Tokyo. The duration is from 2026 Mar. 1 to 2026 Mar. 3 and the budget is 100,000 yen. Include tourist attractions, accommodations, and transportation options. Output the result in a structured format organized by day, and for each activity include an identifier, a location, and a time slot (morning, afternoon, or evening).”

The server explicitly embeds, within the prompt sentence, an output format specification that requires the generative AI model to output the travel itinerary in a predetermined structured manner. For example, the server requires that the generative AI model output activities grouped per day, each activity including fields such as activity identifier, location name, location type, time slot category, and optionally associated cost and duration. By constraining the model output via the prompt sentence, the server reduces the need for complex text parsing and heuristic inference, thus reducing CPU load and memory consumption during parsing.

The server uses a generative AI model implemented as a neural network of the transformer type. The generative AI model includes multiple layers of self-attention and feedforward sub-layers, and has parameters (weights and biases) trained on large text corpora including travel-related descriptions and structured itineraries. The server stores or accesses the generative AI model on specialized hardware that may include graphics processing units or tensor processing units. The server encodes the prompt sentence into a sequence of tokens and feeds these tokens as input to the generative AI model.

The generative AI model processes the input sequence using multi-head attention mechanisms that compute attention weights over prior tokens, and using position encodings that preserve ordering information. The model produces probability distributions over next tokens at each step, and the server controls decoding parameters such as a temperature parameter and a maximum sequence length to influence the diversity and completeness of the generated travel plan. The server uses a decoding algorithm, such as beam search or top-k sampling, to derive a final output token sequence, which is then decoded back into text or into a constrained structured format when the model is trained or prompted to produce delimiters or tags.

The server may train the generative AI model or a fine-tuned variant using a supervised learning procedure. The server prepares training data consisting of pairs of prompt sentences and target outputs representing structured travel plans. The server defines a loss function such as a cross-entropy loss between predicted token distributions and ground-truth tokens. The server performs gradient-based optimization to update the weights of the model, using algorithms such as stochastic gradient descent with momentum or Adam. During training, the server may apply data augmentation such as random rephrasing of travel conditions, variation of budget ranges, or insertion of alternative activities, to improve the robustness of the model in handling diverse instructions. By controlling the architecture, loss function, and training strategy, the server ensures that the generative AI model is able to reliably produce structured travel plans that comply with the requested output format specification.

The server, after obtaining the output from the generative AI model, converts the output into an internal data structure. In one embodiment, the server defines a hierarchical structure where a top-level object represents an entire travel plan, which contains a list of day objects.

Each day object contains a list of activity objects. Each activity object contains at least an activity identifier, a location identifier, a location description, a time slot indicator (for example, morning, afternoon, evening), an optional cost estimate, and optional transport or accommodation references. The server stores this internal data structure in a database optimized for structured query and retrieval. The server maintains referential links between activities and external resources such as transportation schedules and accommodation records.

The server generates digital tour pamphlet data by mapping the internal data structure into a display-oriented representation for the terminal. For example, the server assigns layout metadata to each day and activity, such as a display title, an icon type, color information, and ordering rules. The server may enrich the data by incorporating image references or map links derived from location identifiers. The server generates a compressed representation that minimizes redundant text and uses identifiers and codes that the terminal can map to localized strings or cached media assets. By designing the digital tour pamphlet data as a structured and hierarchical representation aligned with the generative AI model's output format, the server reduces the need for repeated transformation between free-form text and display data, which reduces network payload size and server-side processing time.

The terminal receives the digital tour pamphlet data and renders it on the display using the specified layout metadata. The terminal arranges content by day and by time slot, enabling the user to visually perceive the structure of the itinerary. The terminal may cache part of the digital tour pamphlet data in local storage so that the user can view the itinerary offline. The terminal provides UI elements that allow the user to request modifications, such as changing a preferred activity type, adjusting the budget, or shifting time slots of specific activities.

The user interacts with the digital tour pamphlet displayed on the terminal. The user may select an activity, mark it as undesirable, or indicate a preference such as “prefer museums” or “reduce walking distance.” The terminal converts these user actions into structured change requests or preference information. For example, the terminal associates a “prefer museums” preference with a tag that increases the weight of museum-related activities and decreases the weight of shopping-related activities.

The server receives these change requests and preference information and uses them to generate a new prompt sentence. In one example, the server generates a prompt sentence of the following form:

“Refine the following 3-day Tokyo travel plan with a budget of 100,000 yen. The user prefers museums and historical sites instead of shopping and wants to minimize walking distance.

Adjust the attractions, schedule, and transportation options accordingly. Keep the output structured by day and by time slot, and for each activity include an identifier, a location, and a time slot (morning, afternoon, or evening).”

The server may include a summary of the existing travel plan or the internal data structure as part of the prompt sentence. For instance, the server may list the main activities per day in a concise form. The server thus supplies both the original travel conditions and the update condition (change request and preference information) to the generative AI model in a way that preserves structure. Because the generative AI model is instructed to maintain the structural constraints, the updated output is aligned with the existing internal data schema. As a result, the server can update only the changed parts of the internal data structure and reuse existing data for unchanged parts, thereby reducing computational overhead and memory reallocation.

The server also integrates the internal data structure with reservation processing. The server maps activity identifiers to reservation segments, such as specific transport legs or accommodation intervals. When the user triggers a bulk reservation from the terminal based on the digital tour pamphlet, the terminal sends a bulk reservation request including identifiers of selected activities and any user-selected options (for example, room types or departure time ranges).

The server interprets the bulk reservation request and creates a set of reservation tasks corresponding to the internal data structure. For each transportation resource, the server constructs a request message for a transportation providing apparatus, including departure location, arrival location, date, time window, number of passengers, and any constraints such as class of service. For each accommodation resource, the server constructs a request message for an accommodation providing apparatus, including lodging location, check-in and check-out dates, number of guests, room preferences, and budget constraints.

The server executes these reservation tasks sequentially or in parallel, depending on technical policy and network conditions. The server manages asynchronous network calls and collects responses from external service providing apparatuses, each response including a success or failure indication, a confirmation code, and final price information. The server performs consistency checks to ensure that the reservations are compatible with the travel itinerary. For example, the server verifies that confirmed transport times align with the scheduled activities and that accommodation dates match the itinerary.

By maintaining a consistent internal data structure aligned with the generative AI model's structured output, the server can automatically determine which reservations need to be updated when the travel plan is refined. The server avoids re-generating and re-validating the entire reservation set when only part of the itinerary changes. This reduces the number of external API calls, decreases network traffic, and improves overall system responsiveness.

In one variation, the server employs a rule-based post-processing module that operates on the structured output from the generative AI model. The rule-based module applies optimization rules that are not trivially performed by a human, such as minimizing total travel time subject to budget constraints by comparing multiple candidate transport options, or redistributing activities within the itinerary to minimize overlapping crowds based on predicted congestion profiles. The server applies heuristic or algorithmic methods, such as dynamic programming or shortest-path algorithms, to adjust the internal data structure. Because the output of the generative AI model is already structured by day and time slot, these optimization algorithms can operate directly on structured items rather than parsing free-form text, thereby improving computational efficiency and accuracy.

In another variation, the server maintains a secondary learned model that predicts the likelihood of user satisfaction based on features extracted from the internal data structure, such as activity type distribution, daily travel distance, and time allocation. The server feeds these features into a separate neural network classifier trained using historical feedback data.

The server uses the predicted satisfaction scores to guide the selection or refinement of travel plans. This multi-model architecture demonstrates a technical improvement, because the system combines a generative AI model for content creation with a discriminative model for quality evaluation, using defined feature extraction and structured representations to optimize system output without human intervention.

The technical effects of this system arise from the structured integration between the prompt sentence design, the generative AI model's constrained output, the internal hierarchical data structures, and the reservation orchestration logic. By imposing format constraints in the prompt sentence, the server reduces ambiguity and parsing complexity, which directly reduces CPU cycles and memory usage. By maintaining a unified, reusable internal data structure used both for display (digital tour pamphlet data) and for reservation processing, the server avoids repeated data transformations and redundant data storage, thereby increasing processing speed and reducing storage footprint. By using update conditions and refined prompt sentences that preserve structural constraints, the server enables incremental updates to travel plans, reducing re-computation and communication overhead when user preferences change.

In comparison to a mere automation of human planning, the server executes a sequence of technical operations that a human cannot perform in the same manner, such as managing token-level constraints in the generative AI model, dynamically shaping output formats via prompt engineering, applying algorithmic post-processing on structured data, and orchestrating concurrent reservation transactions based on a machine-managed data graph.

These operations result in improved determinism, reproducibility, and scalability of travel plan generation and reservation processing in the server's computing environment.

The described embodiments can be realized in various deployment configurations. The server may be implemented as a single physical machine or as a cluster of multiple machines, with the generative AI model executed on dedicated accelerator hardware in a separate inference service. The terminal may be a smartphone, a tablet, or another portable information terminal.

The communication network may include wired networks, wireless networks, or combinations thereof. The internal data structures may be stored in a relational database, a document-oriented database, or an in-memory data grid. These variations still maintain the essential technical features: generation of prompt sentences including output format specifications, enforcement of structured output from a generative AI model, maintenance of a unified internal hierarchical data structure, and integration of such structure with digital tour pamphlet generation and bulk reservation orchestration.

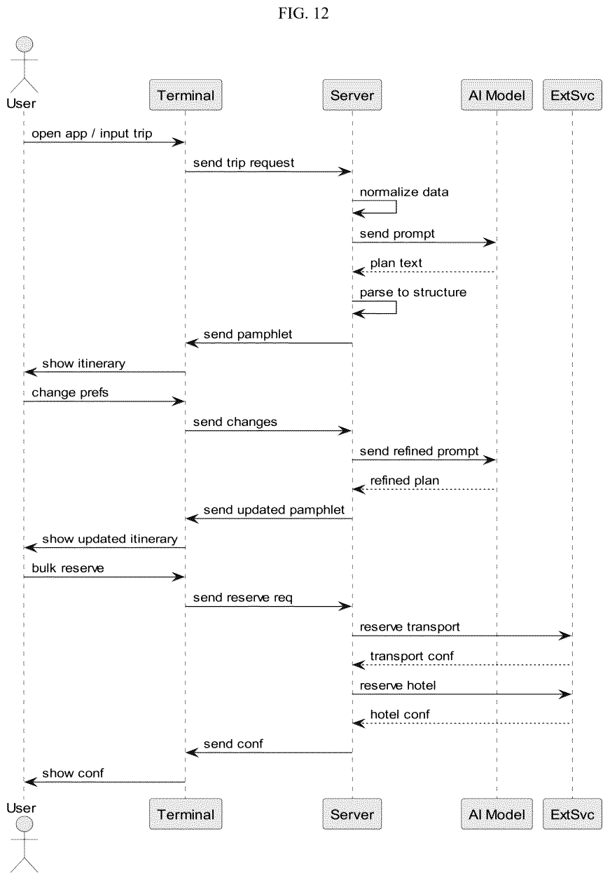

The following describes the processing flow using FIG. 12.

### Step 1:

The user operates the terminal to launch a travel-planning application and to provide travel conditions.

The terminal displays input components such as text fields for destination, date pickers for travel period, numeric fields for budget, and selectable options for preferences (for example, “family trip,” “business trip,” “prefer museums”).

[Input] The user inputs raw values such as a city name, start date, end date, budget amount, and preference selections.

[Processing] The terminal converts the user's actions into structured data by mapping UI fields to keys (for example, “destination,” “start_date,” “end_date,” “budget,” “preferences”) and validating formats (for example, checking that dates are valid and that budget is numeric).

[Output] The terminal generates a validated parameter object representing the travel conditions and caches it in memory as a request candidate.

### Step 2:

The terminal transmits the validated travel conditions to the server.

The terminal serializes the parameter object into a data record (for example, JSON) and attaches authentication information such as a user identifier or token.

[Input] The terminal uses the structured travel condition object produced in Step 1.

[Processing] The terminal establishes a secure network connection, encapsulates the data record in a request message, and issues a network transmission to a predefined server endpoint.

[Output] The terminal outputs a network request containing the user's travel conditions and receives a provisional acknowledgment from the server indicating that the request has been accepted.

### Step 3:

The server receives and normalizes the travel conditions.

The server accepts the network request, decodes the serialized data record, and verifies authentication information.

[Input] The server uses the transmitted travel condition data, including destination, period, budget, and preferences.

[Processing] The server performs data normalization: converting dates to a canonical date-time format, converting budget and currency into a standard internal unit, cleaning text (for example, trimming whitespace, unifying character sets), and mapping preference selections to standardized tags or numeric feature values. The server also checks constraints (for example, that the end date is later than the start date).

[Output] The server produces a normalized travel condition object and stores it in a database record linked to the user identifier.

### Step 4:

The server constructs a prompt sentence including an output format specification.

The server loads a prompt template that defines a textual pattern for instructing the generative AI model.

[Input] The server uses the normalized travel condition object obtained in Step 3.

[Processing] The server inserts values such as destination, start date, end date, and budget into the template using string formatting operations. The server appends an output format specification that defines how the generative AI model should structure the itinerary (for example, by day and by time slot, and including fields such as identifier, location, and time slot).

For example, the server generates a prompt sentence such as:

“Please generate a travel plan for Tokyo. The duration is from 2026 Mar. 1 to 2026 Mar. 3 and the budget is 100,000 yen. Include tourist attractions, accommodations, and transportation options. Output the result in a structured format organized by day, and for each activity include an identifier, a location, and a time slot (morning, afternoon, or evening).”

[Output] The server outputs a finalized prompt sentence string that encodes both the travel conditions and the required output structure.

### Step 5:

The server transmits the prompt sentence to the generative AI model and triggers inference.

The server interfaces with an AI inference module or external AI service that executes a generative AI model based on a transformer architecture.

[Input] The server uses the prompt sentence produced in Step 4 and optional model parameters such as decoding temperature and maximum token count.

[Processing] The server tokenizes the prompt sentence, converts tokens into numerical identifiers, and sends these identifiers along with model parameters to the generative AI model. The generative AI model performs matrix multiplications and attention operations across multiple layers, computes probability distributions over possible next tokens, and generates a sequence of tokens representing the travel plan under the specified constraints.

[Output] The server receives a generated output sequence from the generative AI model, represented as text that follows the requested structured format or as tagged structured content that can be parsed deterministically.

### Step 6:

The server parses the generated travel plan into an internal hierarchical data structure.

The server interprets the generated text or tagged structure according to the output specification defined in the prompt.

[Input] The server uses the generated travel plan output obtained in Step 5.

[Processing] The server identifies day boundaries and time-slot labels (for example, “Day 1, Morning”) and extracts activity segments. For each activity segment, the server identifies the activity identifier, location description, and time slot. The server stores these items in a hierarchical internal data structure: a travel plan object containing day objects, and for each day object, a list of activity objects. The server may also compute derived attributes such as estimated daily cost or approximate travel distance between sequential locations, using additional lookup tables or mapping services.

[Output] The server produces a consistent internal data structure representing the entire itinerary with explicit associations between days, time slots, and activities.

### Step 7:

The server generates digital tour pamphlet data from the internal data structure.

The server converts internal travel plan entities into display-oriented entities, adding layout and presentation information.

[Input] The server uses the hierarchical internal travel plan data generated in Step 6.

[Processing] The server maps each day object to a display section, assigns section titles, and orders activities within each section by time slot. The server enriches activities with presentation attributes, such as icons (for example, “hotel” icon for accommodation, “train” icon for transportation), color schemes, and short display labels. The server constructs a compact representation that references shared resources (for example, a common image for a landmark) by identifier to reduce redundancy.

[Output] The server outputs digital tour pamphlet data, represented as a structured dataset suitable for rendering by the terminal application.

### Step 8:

The server transmits the digital tour pamphlet data to the terminal.

The server prepares a response message that contains the digital tour pamphlet data and metadata such as a plan identifier and version information.

[Input] The server uses the digital tour pamphlet data from Step 7 and user or session identifiers associated with the request.

[Processing] The server serializes the data into a format understood by the terminal application and encapsulates the data in a network response. The server may compress the payload or apply other optimization techniques to reduce communication load.

[Output] The server sends the serialized digital tour pamphlet data to the terminal, and the terminal receives this data as a response message.

### Step 9:

The terminal renders the digital tour pamphlet on the display.

The terminal converts the received structured data into user interface components.

[Input] The terminal uses the digital tour pamphlet data transmitted in Step 8.

[Processing] The terminal parses the structured data and maps day sections and activity items to view objects such as tabs, cards, and list elements. The terminal applies the layout metadata to determine order, grouping, icons, and colors. The terminal may perform local caching of the data for offline viewing and precompute view states for smooth scrolling and interaction.

[Output] The terminal displays the digital tour pamphlet to the user, presenting the itinerary organized by day and by time slot.

### Step 10:

The user reviews the itinerary and optionally specifies change requests or preferences.

The user inspects day-by-day activities, transportation items, and accommodations shown on the terminal.

[Input] The user uses the rendered pamphlet view as visual input and identifies elements to modify, such as activities or budgets.

[Processing] The user performs UI actions such as tapping an activity to remove it, selecting an alternative category (for example, “more museums, fewer shopping locations”), or adjusting a slider to change the budget. These actions are recorded by the terminal as structured change requests (for example, an array of operations such as “delete activity A1”, “add preference tag: museums”) and preference values.

[Output] The terminal produces a change-request object and an updated preference object reflecting the user's instructions.

### Step 11:

The terminal transmits change requests and preferences to the server for refinement.

The terminal prepares a refinement request containing references to the plan identifier and structured updates.

[Input] The terminal uses the change-request and preference objects produced in Step 10 together with the plan identifier.

[Processing] The terminal serializes these objects, attaches necessary authentication information, and transmits them as a refinement request message to the server over the network.

[Output] The terminal sends a refinement request that the server can interpret to produce a refined travel plan.

### Step 12:

The server generates a new prompt sentence for refining the travel plan and invokes the generative AI model.

The server constructs a prompt sentence that includes both original travel conditions and newly specified update conditions.

[Input] The server uses the stored internal travel plan structure, the original normalized travel conditions from Step 3, and the change-request and preference objects from Step 11.

[Processing] The server assembles a synthesis of constraints and context, such as “3-day Tokyo trip,” “budget 100,000 yen,” and “prefer museums, minimize walking distance,” into a refined prompt sentence. The server may also include a concise enumeration of current daily activities as context. An example of such a prompt sentence is:

“Refine the following 3-day Tokyo travel plan with a budget of 100,000 yen. The user prefers museums and historical sites instead of shopping and wants to minimize walking distance.

Adjust the attractions, schedule, and transportation options accordingly. Keep the output structured by day and by time slot, and for each activity include an identifier, a location, and a time slot (morning, afternoon, or evening).”

The server sends this refined prompt sentence to the generative AI model with appropriate model parameters, performs inference as in Step 5, and retrieves updated structured output.

[Output] The server acquires a refined travel plan output, aligned with the specified structure and user preferences.

### Step 13:

The server updates the internal data structure and regenerates digital tour pamphlet data.

The server incorporates changes from the refined output into the existing plan representation.

[Input] The server uses the refined travel plan output from Step 12 and the current internal travel plan structure from Step 6.

[Processing] The server compares activity identifiers and day structures between the new output and the existing structure. The server updates or replaces only the changed activities or days, preserving unaffected data segments to minimize recomputation. The server then regenerates digital tour pamphlet data by reapplying presentation mapping as in Step 7, but only for updated sections where possible, thereby conserving processing resources.

[Output] The server produces updated digital tour pamphlet data and stores a new version of the travel plan linked to the plan identifier.

### Step 14:

The server transmits the updated digital tour pamphlet data, and the terminal refreshes the display.

The server prepares and sends a response containing the new pamphlet representation.

[Input] The server uses the updated digital tour pamphlet data created in Step 13. The terminal uses its current UI state and the plan identifier.

[Processing] The server serializes and sends the updated data to the terminal. The terminal receives the updated data, compares version identifiers, and selectively updates only the affected UI elements (for example, a specific day's activities). The terminal may perform diff-based UI updates to minimize redraw and to preserve user scroll position.

[Output] The terminal presents a refined itinerary reflecting the user's change requests and preferences while maintaining interaction continuity.

### Step 15:

The user initiates a bulk reservation based on the digital tour pamphlet.

The user reviews the finalized itinerary and decides to reserve all or a subset of the services.

[Input] The user examines the displayed itinerary and uses selection controls to select which transportation and accommodation items to include in the reservation.

[Processing] The user actuates a “Book all” or similar command on the terminal. The terminal compiles a list of selected activity identifiers that correspond to reservable segments (for example, flights, trains, and hotels) and associates them with required parameters such as number of travelers and room type.

[Output] The terminal generates a bulk reservation request object that references the current plan identifier and selected segments.

### Step 16:

The terminal sends the bulk reservation request to the server.

The terminal initiates a reservation workflow by contacting the server.

[Input] The terminal uses the bulk reservation request object created in Step 15.

[Processing] The terminal serializes the request, attaches user identity and payment-related metadata as permitted, and transmits the request to the server through a secure channel.

[Output] The terminal outputs a network message representing the bulk reservation request.

### Step 17:

The server orchestrates external reservation processing based on the internal travel plan.

The server transforms the bulk reservation request into specific reservation tasks for external service providing apparatuses.

[Input] The server uses the bulk reservation request from Step 16 and the internal hierarchical data structure from Steps 6 and 13.

[Processing] The server resolves each selected activity identifier into concrete reservation parameters: for transportation, departure and arrival locations, dates, and time windows; for accommodation, check-in and check-out dates and lodging locations. The server creates reservation messages for each external service providing apparatus and issues them in a controlled sequence or in parallel, handling asynchronous responses and retries on failures.

The server performs logical checks to ensure that confirmed reservations align with the itinerary and, if necessary, adjusts or cancels conflicting segments before final confirmation.

[Output] The server generates a consolidated set of reservation results, including confirmation codes, final prices, and any failed or alternative options.

### Step 18:

The server generates bulk reservation result information and transmits it to the terminal.

The server assembles a summary suitable for user display.

[Input] The server uses the consolidated reservation results from Step 17.

[Processing] The server structures the reservation results in a format that maps to specific itinerary segments in the internal data structure, attaching confirmation identifiers and status flags to each segment. The server compiles this into bulk reservation result information, including overall success status and total cost, and serializes the information for transmission to the terminal.

[Output] The server outputs the bulk reservation result information to the terminal as a response to the bulk reservation request.

### Step 19:

The terminal displays reservation confirmations and stores them for later access.

The terminal presents the result of the bulk reservation to the user.

[Input] The terminal uses the bulk reservation result information received in Step 18.

[Processing] The terminal parses the result information and updates the digital tour pamphlet view to include reservation status indicators and confirmation codes next to each reservable segment. The terminal may write key reservation data (for example, confirmation codes, dates, and provider names) into local storage for offline access. The terminal may also generate calendar entries or notifications based on the reservation details.

[Output] The terminal shows a finalized, reservation-aware itinerary to the user and maintains a locally stored record of the confirmed reservations.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented travel planning systems typically require a user to perform separate search, evaluation, and reservation operations for transportation, accommodation, and sightseeing resources across multiple heterogeneous service platforms. In such systems, a processor generally treats user input as simple query parameters and forwards the parameters independently to route search services, accommodation reservation services, and sightseeing information services. As a result, the processor does not generate a unified, constraint-consistent itinerary, but instead returns fragmented lists of candidates that the user must manually compare, sequence, and reconcile with temporal and budgetary constraints. This architecture leads to several technical problems.

First, the processor is not configured to convert user intent, expressed in natural language travel requirements and preferences, into a machine-interpretable, end-to-end itinerary structure. The lack of an internal representation that links days, times, movement segments, facilities, and visit places prevents the processor from performing global optimization and consistency checking. The system therefore cannot automatically detect conflicts such as overlapped movement segments, violation of opening hours, or exceeding of budget, and relies on user intervention and repeated network queries. This causes unnecessary processor load due to redundant searches and increases latency because the server must wait for a large number of independent user-driven operations.

Second, conventional systems do not leverage generative artificial intelligence models in a way that is tightly integrated with structured data processing. When a generative AI model is used merely as a front-end text generator, the output remains unstructured and cannot be directly consumed by backend scheduling and reservation logic. The server must either disregard the generated text or manually parse it with ad-hoc rules, which is error-prone and computationally inefficient. This results in poor utilization of computational resources, and does not significantly improve the core behavior of the travel planning system as a computing apparatus.

Third, existing architectures do not provide a robust, computer-controlled mechanism for collective reservation that reacts adaptively to failures. Typically, once the user selects options, the server issues independent reservation requests. If any reservation fails, the server either returns a generic error or requires the user to restart the entire planning and booking process. There is no automated feedback loop between reservation results and plan generation, and no mechanism for dynamically updating the itinerary using AI-assisted reasoning. This leads to inefficient use of network resources due to repeated manual retries and does not improve the reliability or stability of the reservation workflow at the system level.

Fourth, many systems present the result as separate pages or simple lists, without generating a unified digital information medium that is both machine-readable and human-readable. This limits interoperability with other applications (for example, calendar software or ticket management tools) and prevents efficient downstream processing. It also increases the complexity of client-side rendering because the client must reconstruct a coherent itinerary from disjointed fragments.

Accordingly, there is a need for a computerized travel planning and reservation system in which a processor is specifically configured to: (i) receive and interpret user travel condition information; (ii) generate and submit a prompt sentence to a generative AI model; (iii) convert the natural language output of the model into structured travel plan data; (iv) integrate external route, accommodation, and sightseeing information services; (v) algorithmically adjust the plan to satisfy temporal and budget constraints; (vi) generate a unified digital information medium in both machine-readable and human-readable formats; and (vii) execute and adapt a collective reservation process based on the plan and on reservation success or failure. By redesigning the internal processing flow and data structures in this manner, the invention improves the functioning of the server as a computing system, reduces redundant network accesses and user interactions, and enhances the efficiency, reliability, and automation level of the travel planning and booking pipeline.

The specific processing by the specific processing unit 290 of the data processing device 12 in Example 2 is realized by the following means.

The present invention provides a server comprising a processor configured to receive travel condition information as input information from a terminal, analyze the travel condition information to generate a prompt sentence that instructs a generative artificial intelligence model to generate a travel plan satisfying the travel condition information, input the prompt sentence to the generative artificial intelligence model and obtain, from the generative artificial intelligence model, a travel plan proposal expressed in natural language, analyze the travel plan proposal to generate structured travel plan data by extracting elements corresponding to a travel schedule, movement means, stay facilities, and visit places, obtain route information and movement cost by using an external connection function for route information acquisition provided by a route information providing apparatus based on the structured travel plan data, obtain stay facility information and stay cost by using an external connection function for stay facility information acquisition provided by a stay facility reservation apparatus based on the structured travel plan data, and obtain visit place information and required fee by using an external connection function for visit place information acquisition provided by a sightseeing information providing apparatus based on the structured travel plan data, compute, based on the obtained route information, stay facility information, and visit place information, a sequence of activities and associated times for each travel day so as to satisfy movement times, opening times, admission times, stay facility check-in and check-out times, and budget constraints, and adjust the structured travel plan data to generate an updated, realistic travel plan, generate a digital information medium including the updated travel plan in a machine-readable format and in a human-readable format and transmit the digital information medium to the terminal, receive, from the terminal, a reservation request for collectively reserving the movement means, the stay facilities, and the visit places included in the digital information medium, execute a collective reservation process by transmitting reservation information to the route information providing apparatus, the stay facility reservation apparatus, and the sightseeing information providing apparatus based on the reservation request, and, in the collective reservation process, acquire success or failure information for each reservation and, when failure information is acquired, generate an additional prompt sentence for the generative artificial intelligence model to search for alternative movement means, stay facilities, or visit places, update the travel plan based on a response from the generative artificial intelligence model, and retransmit reservation information based on the updated travel plan. This enables a technical improvement in the operation of the server as a computing apparatus by automatically transforming high-level user travel conditions into a consistent, constraint-satisfying itinerary, tightly integrating generative AI output with structured data processing, reducing redundant user interactions and network accesses through automated adjustment and re-planning in response to reservation failures, and providing a unified digital information medium that supports both efficient machine processing and clear human presentation.

The term “processor” refers to a hardware circuit or computing resource, such as a central processing unit or a dedicated processing device, configured to execute instructions and perform the operations described in the claims.

The term “terminal” refers to an information processing device operated by a user, such as a client computing device, that transmits input information to the server and receives and displays a digital information medium.

The term “travel condition information” refers to input information indicating requirements and preferences of a user for a trip, including at least one of an origin, a destination, a travel period, a budget, a number of travelers, and user preferences regarding movement means, stay facilities, and visit places.

The term “prompt sentence” refers to machine-processable text that encodes instructions and conditions for a generative artificial intelligence model to generate a travel plan in response to the travel condition information.

The term “generative artificial intelligence model” refers to a trained machine learning model configured to generate natural language text output, such as a travel plan proposal, in response to a prompt sentence.

The term “travel plan proposal” refers to a travel itinerary described in natural language, including at least a sequence of days and associated activities for a trip, as generated by the generative artificial intelligence model.

The term “structured travel plan data” refers to data in a machine-interpretable format that represents the content of a travel plan proposal as a structured set of elements, including at least elements for a travel schedule, movement means, stay facilities, and visit places.

The term “travel schedule” refers to information defining temporal allocation of activities within a trip, including at least dates, times, and sequences of activities.

The term “movement means” refers to a mode of transportation used by a traveler between locations, including at least one of a rail service, a road vehicle service, an air transport service, and a water transport service.

The term “stay facility” refers to a facility at which a traveler can stay overnight or for a specified period, including at least one of a lodging facility, a rental facility, and a temporary accommodation facility.

The term “visit place” refers to a location to be visited during a trip, including at least one of a sightseeing facility, a cultural facility, a natural attraction, and a commercial facility.

The term “route information providing apparatus” refers to an external information processing system that provides route information and movement cost information for movement means in response to a query.

The term “stay facility reservation apparatus” refers to an external information processing system that provides information related to stay facilities, including availability and price, and accepts reservation information for the stay facilities.

The term “sightseeing information providing apparatus” refers to an external information processing system that provides information related to visit places, including at least opening times, required fees, and location information.

The term “external connection function” refers to a communication function that enables the processor to send a request to, and receive a response from, an external information processing system via a communication network using a predefined communication protocol.

The term “route information acquisition” refers to a process of obtaining, from the route information providing apparatus, data defining at least one of a movement route, a movement time, a movement schedule, and a movement cost between locations.

The term “stay facility information acquisition” refers to a process of obtaining, from the stay facility reservation apparatus, data defining at least one of a stay facility identifier, a stay period, an availability status, and a stay cost.

The term “visit place information acquisition” refers to a process of obtaining, from the sightseeing information providing apparatus, data defining at least one of a visit place identifier, an opening time, an admission condition, and a required fee.

The term “movement time” refers to a duration or schedule required for a traveler to move between locations using a movement means.

The term “opening time” refers to a time range during which a visit place accepts visitors.

The term “admission time” refers to a time or time range at which a traveler can enter a visit place, subject to at least one of opening time and reservation conditions.

The term “check-in time” refers to a time or time range at which a traveler is permitted to start a stay at a stay facility.

The term “check-out time” refers to a time or time range at which a traveler is required to end a stay at a stay facility.

The term “budget constraints” refers to one or more conditions that limit a total allowable cost for a trip, including at least an upper limit on a sum of movement costs, stay costs, and required fees.

The term “realistic travel plan” refers to structured travel plan data adjusted so that scheduled activities and movements satisfy temporal constraints, budget constraints, and availability constraints obtained from external information processing systems.

The term “digital information medium” refers to data representing a travel plan that is stored or transmitted in an electronic form and that includes at least one machine-readable format and at least one human-readable format.

The term “machine-readable format” refers to a data format structured for processing by a computing apparatus, including at least one of a markup format, a serialization format, and a structured document format.

The term “human-readable format” refers to a data format configured for display to a user, including at least one of formatted text, tabular information, and graphical layout information.

The term “electronic brochure format” refers to a human-readable format of the digital information medium in which activities, movement means, stay facilities, and visit places are visually separated and organized by travel day for display on a terminal.

The term “reservation request” refers to information transmitted from the terminal to the server that requests reservation of at least one of movement means, stay facilities, and visit places in accordance with a travel plan.

The term “collective reservation process” refers to a process in which the processor uses a travel plan to generate and transmit reservation information for multiple movement means, stay facilities, and visit places in a coordinated manner, such that the reservations are performed together rather than as isolated individual reservations.

The term “reservation information” refers to data transmitted to an external information processing system for the purpose of reserving a movement means, a stay facility, or a visit place, including at least identification of the resource, a desired time or period, and traveler information.

The term “success or failure information” refers to information received from an external information processing system indicating whether a reservation requested by the server has been accepted or rejected.

The term “additional prompt sentence” refers to a prompt sentence generated by the processor after acquisition of failure information, for instructing the generative artificial intelligence model to generate alternative elements for a travel plan.

The term “alternative movement means, stay facilities, or visit places” refers to elements proposed in place of original movement means, stay facilities, or visit places that failed to be reserved, while maintaining consistency with travel condition information and constraints.

In one embodiment, a server cooperates with a terminal operated by a user to implement a travel planning and collective reservation system. The server includes at least one processor and a memory, and is realized, for example, on a general-purpose computer system such as a rack-mount server or a virtual machine provided by a cloud computing platform. The server runs an operating system such as a server-class operating system and executes application programs implemented, for example, using a server-side framework.

The terminal is realized, for example, as a smartphone, a tablet, or a personal computer executing a web browser or a native application.

The server stores, in the memory, program modules including at least: an input information reception module, a travel condition analysis module, a prompt generation module, a generative AI interface module, a natural language plan parsing module, a structured plan generation module, an external information acquisition module, a constraint satisfaction and schedule adjustment module, a digital information medium generation module, and a collective reservation control module. The server further stores, in the memory or an external storage device, definition data for data structures used for representing structured travel plan data, as well as configuration parameters specifying budget thresholds, time tolerances, and communication parameters for external systems.

The terminal provides a user interface that allows the user to input travel condition information. The user inputs, for example, an origin, a destination, a number of days and nights, a total budget, and preferences such as a preferred movement means, preference for historical sites, preference for local food, or a maximum acceptable number of movements per day. The terminal formats this information as structured data and transmits it to the server via a communication network using a secure communication protocol.

The server receives the travel condition information and stores it as an internal travel condition object. The server represents the travel condition object using a structured data type, for example, a set of fields including an origin identifier, a destination identifier, a travel period, a numeric budget value, a list of user preferences, and one or more constraint parameters such as a maximum daily walking distance or a maximum number of hotel changes. The server normalizes each field by mapping human-readable location names to internal identifiers, normalizing date formats, and converting currency units to a standard unit.

The server generates a prompt sentence based on the normalized travel condition object. The server constructs the prompt sentence as a concatenation of (i) a system-level instruction string describing the role and constraints of the generative AI model and (ii) a user-level description of the travel conditions. In one example, the server generates the following prompt sentence as the main user-level content:

“Create a realistic 4-day, 3-night travel plan from Tokyo to Kyoto with a maximum budget of 100,000 yen. The user prefers to travel mainly by train and is interested in historical sites and local food. Provide a day-by-day schedule including transportation, accommodations near major attractions, sightseeing spots such as temples and traditional streets, approximate times, and estimated costs for each item.”

In another example, the server uses a second type of prompt sentence that includes structured plan data and requests refinement:

“Given the following structured itinerary, generate a clear and friendly explanation for the user, without changing the schedule or exceeding the total budget: [structured itinerary description].”

The server supplies the prompt sentence to a generative AI model. In one embodiment, the generative AI model is implemented as a transformer-type neural network with multiple encoder-decoder layers or decoder-only layers, multi-head self-attention mechanisms, and feed-forward sub-layers. The server stores, in the memory, model parameters including token embeddings, positional embeddings, attention weights, and feed-forward weights. The server acquires the trained weights in advance by performing supervised learning on a large corpus of travel-related text or by using a general-purpose language model fine-tuned on travel itineraries.

The server provides the prompt sentence to the generative AI model as an input token sequence. The server converts the prompt sentence into tokens using a subword tokenization algorithm such as byte pair encoding or a similar segmentation method. The server then maps the tokens to embedding vectors and performs numerical operations including matrix multiplications, attention score computations, softmax operations, and non-linear activations.

The generative AI model processes the token sequence in a sequence-to-sequence generation process and outputs a sequence of tokens representing a travel plan proposal described in natural language.

The server receives the generated token sequence and converts it back into text. The travel plan proposal typically contains daily headings (for example, “Day 1”), time-ordered activities, movement descriptions, accommodations, and sightseeing spots, as well as approximate cost information. The server does not simply display this text; instead, the server parses the proposal to generate structured travel plan data.

The server uses a natural language plan parsing module to segment the travel plan proposal by day, by activity, and by type of element. The server identifies, for example, temporal expressions, place names, transportation terms, and cost expressions. In one embodiment, the server combines pattern-based rules and a statistical tagging model for this purpose. The server identifies entities such as movement means, stay facilities, and visit places, and associates them with specific days and times. The server stores the results in an internal data structure in which each day is represented by an ordered list of events, each event including fields for event type, start time, end time, location identifier, related cost, and links to external service identifiers when known.

The server uses an external information acquisition module to obtain detailed and up-to-date information associated with the structured elements. The server communicates with a route information providing apparatus to obtain route options, detailed schedules, and fares between specific points, given travel dates and rough time windows inferred from the travel plan proposal. The server sends, for example, an origin coordinate, a destination coordinate, and a preferred departure time, and receives route information including specific transportation lines, departure and arrival times, transfer locations, and fare amounts. The server also communicates with a stay facility reservation apparatus to obtain availability and prices of lodging facilities corresponding to the days and locations indicated in the plan. The server transmits stay dates, number of persons, budget range, and location constraints, and obtains a list of candidate facilities, each with a facility identifier, room types, daily rates, and cancellation rules. Likewise, the server communicates with a sightseeing information providing apparatus to obtain opening times, addresses, admission fees, and other attributes for visit places referenced in the plan proposal.

The server integrates the external information into the structured travel plan data. The server replaces approximate times and estimated costs in the initial plan proposal with precise schedule and price values obtained from the external systems. The server maps textual place names suggested by the generative AI model to canonical identifiers used by the external systems. When multiple candidate matches exist, the server selects the one that best satisfies user preferences such as proximity to a region or rating thresholds.

The server performs constraint satisfaction and schedule adjustment using the integrated structured travel plan data. The server uses a scheduling algorithm that iterates over all days and events, computing movement times between locations using the route information, and checking each event against temporal constraints such as opening times of visit places and check-in/check-out times of stay facilities. The server also sums individual cost components to compute daily and total costs and compares them with the budget constraint. When conflicts are detected, for example, when an event is scheduled after closing time or when total cost exceeds the budget, the server adjusts the events by shifting time slots, swapping events across days, or removing or replacing lower priority events.

The server may, in some embodiments, use a rule-based priority system for adjustment, in which events are annotated with importance levels, and less important events are preferentially moved or removed. The server may also call the generative AI model again with an additional prompt sentence that explicitly describes a conflict and requests suggestions for alternative movement means, stay facilities, or visit places that satisfy specific constraints such as a maximum travel time or a lower cost. In this case, the server applies a non-standard, computer-oriented workflow in which the generative AI model is used not merely to rephrase text, but to propose new structured options under programmatically defined constraints.

The server generates a digital information medium including the adjusted travel plan. The server produces, for example, a machine-readable representation in a structured format and a human-readable representation in an electronic brochure format. The machine-readable representation includes, as structured travel plan data, a hierarchical structure of days, events, event types, time ranges, locations, transportation identifiers, stay facility identifiers, visit place identifiers, and costs. This representation allows other computer programs, such as calendar synchronizers or ticket management applications, to consume the itinerary without manual interpretation.

The human-readable representation is generated, for example, as a markup document or a fixed-layout document. The server arranges, for each travel day, an ordered list of activities, movement segments, stay facilities, and visit places, with visual separation and clear labeling.

The server may insert icons or graphical markers for movement means and annotate each event with time and cost information. The server transmits this digital information medium to the terminal, which displays it to the user on a graphical interface.

The server also controls a collective reservation process based on the structured travel plan data. After the user confirms the displayed plan on the terminal and submits a reservation request, the server obtains the request and reads the associated structured plan. The server then sequentially or concurrently transmits reservation information for each movement segment, each stay facility, and each visit place that requires reservation, to the respective external systems. The server handles reservation responses and maintains success or failure information for each booked element.

When a reservation failure occurs for a particular element, the server does not simply delegate the problem back to the user. Instead, the server uses the stored structured travel plan data and the failure information to automatically search for alternative elements. The server may internally apply deterministic rules such as lowering the price ceiling by a fixed ratio or widening the acceptable time window within a bounded range, or may use an additional prompt sentence to request the generative AI model to propose alternative elements that satisfy explicit constraints including new time or cost ranges. The server then re-integrates any proposed alternative elements into the structured travel plan data, re-executes the constraint satisfaction and schedule adjustment logic, and attempts reservations again. Through this feedback loop, the server reduces the number of user-initiated retries and lowers the number of network transactions needed to arrive at a fully booked itinerary.

From a technical standpoint, the server improves the functioning of the computer system in several ways. First, by converting natural-language travel condition information into a structured internal representation and by tightly coupling the generative AI model output with structured data processing and external system integration, the server reduces the number of redundant queries and avoids repeated user-driven trial-and-error cycles. This leads to reduced network communication load and lower server-side processing time per successfully booked trip.

Second, the server uses specific data structures and scheduling algorithms that enable global constraint checking across multiple days, multiple movement segments, and multiple stay facilities. This allows the server to detect and eliminate infeasible itineraries before they are presented to the user or before reservation requests are sent, thereby reducing error rates and improving overall plan accuracy. The server's algorithmic adjustment of event sequences and times, based on acquired movement times and opening times, leads to a more efficient use of computation since it avoids repeated full re-planning by exploiting existing structured data.

Third, the server uses the generative AI model in a non-conventional manner, not merely as a natural language interface, but as an element of a closed-loop optimization process that generates alternative options under programmatic constraints. The server explicitly encodes constraints and failure cases into prompt sentences, and uses the model's output as candidate elements to feed back into deterministic scheduling and reservation logic. This hybrid architecture reduces the search space that must be explored by deterministic algorithms alone and achieves better trade-offs between computational cost and solution quality.

Fourth, the server's generation of a unified digital information medium in both machine-readable and human-readable forms improves data management and interoperability. Other systems can import the structured data directly, for example, to generate calendar entries or to synchronize with additional service providers. This avoids repeated parsing of unstructured text and enhances computational efficiency in downstream processing.

In another embodiment, the server employs different types of generative AI models, such as smaller transformer networks optimized for on-premise deployment or larger models executed through a remote inference service. The server may choose which model to use based on the size of the travel condition information or based on a required response time.

The server may also optionally incorporate an ensemble of models, for example, using one model to generate an initial plan and another model, fine-tuned for constraint minimization, to refine or compress the plan.

In still another embodiment, the server trains or fine-tunes the generative AI model using a domain-specific dataset of historical itineraries, reservation success records, and user satisfaction scores. The server uses this dataset to perform gradient-based optimization, where an error function measures discrepancy between generated plans and target realistic plans, and where model weights are updated using optimization algorithms such as stochastic gradient descent or variants thereof. The server may apply data augmentation methods, such as temporally shifting events or synthetically combining segments from multiple itineraries, to increase the robustness of the model. By adjusting the model parameters in this way, the server improves the accuracy of the initial plan proposals and reduces the number of subsequent adjustment iterations required.

In yet another embodiment, the server supports multiple alternative schedule adjustment strategies. For example, the server can prioritize minimization of total travel time, maximization of stay facility rating, or minimization of total cost, depending on user preferences specified in the travel condition information. The server adjusts its internal objective function, which is applied during the schedule adjustment process, by changing weight coefficients associated with time, cost, and rating factors. This results in a flexible, technically optimized planning behavior that can be tuned without redesigning the overall architecture.

Through these embodiments, the server, terminal, and user interact in a manner that allows the system to implement the claimed invention concretely. The server is not limited to any particular hardware or software platform, and the generative AI model is not limited to a specific architecture, as long as it can generate natural-language travel plan proposals in response to a prompt sentence and can operate within the described structured data processing and reservation control framework.

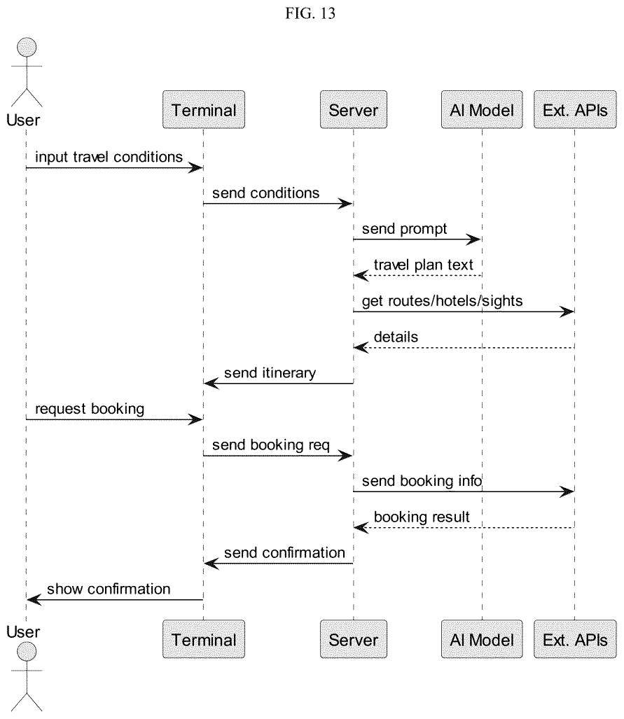

The following describes the processing flow using FIG. 13.

### Step 1:

User operates the terminal to input travel condition information.

User views an input screen on the terminal and enters values such as origin, destination, travel start date, travel end date, number of travelers, total budget, preferred movement means, and interests (for example, historical sites, local food).

Input: Free-form text and selections entered on the terminal UI (for example, “Tokyo to Kyoto, 3 nights 4 days, budget 100,000 yen, prefer train, like temples and local food”).

Output: Structured form data inside the terminal (for example, internal fields for origin, destination, dates, budget, preferences).

User confirms the input and issues a submission operation (for example, tapping a “Generate Plan” button), which causes the terminal to proceed to network transmission.

### Step 2:

Terminal structures and transmits the travel condition information to the server.

Terminal converts the form data into a structured data object, assigns standardized field names, and performs simple validation (for example, checking that required fields are not empty and that dates are in chronological order).

Input: Form data containing user entries.

Data processing: Terminal maps text fields to internal keys (for example, ‘origin’, ‘destination’, ‘budget’) and converts date strings into a standard format; the terminal may convert numeric strings into integer or floating-point types.

Output: A structured travel condition message (for example, a JSON payload) transmitted via a communication protocol to an API endpoint of the server.

### Step 3:

Server receives and normalizes the travel condition information.

Server accepts the structured message, parses it, and stores it in memory as an internal travel condition object.

Input: Structured travel condition message from the terminal.

Data processing: Server parses the message, maps location names to canonical location identifiers via a location dictionary, converts all monetary values to a standard currency unit, and validates ranges (for example, budget >0, date range not exceeding a maximum).

Output: Normalized travel condition object with standardized identifiers, normalized dates, normalized budget, and a cleaned preference list.

### Step 4:

Server generates a base prompt sentence for the generative AI model.

Server constructs a natural-language description of the user's request using the normalized travel condition object.

Input: Normalized travel condition object (origin ID, destination ID, dates or day count, budget, movement preference, interest tags).

Data processing: Server applies template generation logic: it inserts parameter values into a prompt template, combines them with instruction phrases that define constraints and output format rules, and concatenates them into a single coherent text string.

Output: A base prompt sentence, for example:

“Create a realistic 4-day, 3-night travel plan from Tokyo to Kyoto with a maximum budget of 100,000 yen. The user prefers to travel mainly by train and is interested in historical sites and local food. Provide a day-by-day schedule including transportation, accommodations near major attractions, sightseeing spots such as temples and traditional streets, approximate times, and estimated costs for each item.”

### Step 5:

Server forms a model-ready prompt structure and tokenizes it.

Server wraps the base prompt sentence together with system-level instructions into a structure suitable for the generative AI model, and converts it into tokens.

Input: Base prompt sentence and system instruction text (for example, “You are a travel planning assistant. Respect budget and time constraints.”).

Data processing: Server concatenates the texts into a single sequence or into a role-tagged structure; server applies a tokenization algorithm (for example, byte pair encoding) to convert characters into a sequence of subword tokens; server maps tokens to numerical indices used by the generative AI model.

Output: Model-ready prompt structure, including an ordered list of token IDs and associated metadata (for example, role markers, sequence length).

### Step 6:

Server executes the generative AI model to produce a travel plan proposal.

Server forwards the tokenized prompt to the generative AI model and runs a forward-pass computation through the neural network.

Input: Sequence of token IDs representing the prompt sentence and instructions.

Data processing: Generative AI model computes embeddings, applies multi-head self-attention across tokens, passes intermediate representations through feed-forward layers, and iteratively predicts next tokens using a probability distribution (softmax over vocabulary) until an end-of-sequence condition is met. The server may control generation parameters such as maximum length and randomness.

Output: A sequence of output token IDs representing a natural-language travel plan proposal (for example, text describing Day 1 to Day 4 activities with rough times, movements, accommodations, and costs).

### Step 7:

Server detokenizes and segments the travel plan proposal.

Server converts output token IDs into text and then divides the text into structural units.

Input: Sequence of output token IDs from the generative AI model.

Data processing: Server maps each token ID back to text segments, joins them into a full string, and applies segmentation rules based on patterns (for example, “Day 1”, “Day 2” headings), line breaks, and punctuation to separate days and activities.

Output: A set of day-level text segments and activity-level text segments that together form the travel plan proposal in natural language.

### Step 8:

Server parses the travel plan proposal into structured travel plan data.

Server identifies dates, times, locations, movement descriptions, accommodations, and visit places within each segment and converts them into structured entries.

Input: Segmented travel plan text (day headers and activity descriptions).

Data processing: Server applies natural language parsing, including named entity recognition and pattern matching, to detect event types (movement, stay, visit, free time), extract temporal expressions (“morning”, “14:00”), estimate time ranges, and extract place names and approximate costs. Server groups extracted elements by day and transforms them into an internal itinerary object in which each event is represented by fields such as ‘type’, ‘approx_start_time’, ‘approx_end_time’, ‘place_name’, and ‘approx_cost’.

Output: Preliminary structured travel plan data, with days and ordered lists of events each containing approximate times, locations, and costs.

### Step 9:

Server resolves place names and movement segments to canonical identifiers.

Server maps free-form place names and movement descriptions to internal identifiers that external systems recognize.

Input: Preliminary structured travel plan data with textual place names and general movement descriptions (for example, “take a bullet train from Tokyo to Kyoto”).

Data processing: Server queries internal or external lookup tables to map place names to canonical IDs, coordinates, or categories (for example, “Kyoto Station” to a station identifier). For movement segments, server extracts origin and destination locations and identifies movement type (rail, road, air).

Output: Structured travel plan data enriched with canonical identifiers for stay facilities (where possible), stations, landmarks, and inferred movement types.

### Step 10:

Server acquires detailed route information for movement events.

Server communicates with a route information providing apparatus to obtain specific routes, schedules, and fares for each movement event.

Input: Movement events in the structured travel plan data, each with origin ID, destination ID, approximate departure or arrival times, and movement type.

Data processing: Server formulates route search queries (including origin, destination, date, time window, and movement constraints), sends them via an external connection function, receives route candidates, and selects appropriate routes based on criteria (for example, travel time, number of transfers, and cost).

Output: Updated movement events containing concrete departure times, arrival times, route identifiers, transfer points, and precise fare values.

### Step 11:

Server acquires stay facility information for lodging events.

Server accesses a stay facility reservation apparatus to obtain available lodging options that match the plan and constraints.

Input: Lodging events in the structured travel plan data, with target location area, dates, and budget limits derived from the travel condition information.

Data processing: Server sends queries specifying check-in/check-out dates, number of guests, location constraints, and price range; server receives lists of candidate facilities with availability, rates, and attributes; server applies selection logic to choose a facility that best fits the budget and preferences (for example, prioritize proximity to certain visit places or minimum rating).

Output: Lodging events augmented with specific facility identifiers, room types, nightly rates, total stay cost, and check-in/check-out time ranges.

### Step 12:

Server acquires sightseeing information for visit place events.

Server communicates with a sightseeing information providing apparatus to enrich visit place events with operational details.

Input: Visit place events with canonical place identifiers or names and target dates.

Data processing: Server sends queries containing place identifiers and desired visit dates; server receives attributes such as opening times, closing times, admission fees, and location coordinates; server attaches these attributes to the visit place events.

Output: Visit place events populated with opening hours, required fees, precise locations, and any additional constraints (for example, reservation required).

### Step 13:

Server performs schedule consistency checks and time allocation.

Server examines all events for each day and calculates feasible times based on movement durations and opening constraints.

Input: Structured travel plan data with enriched movement, lodging, and visit place events including specific times and constraints.

Data processing: Server computes travel times between consecutive events using route durations and inter-location distances; server checks whether arrival times respect opening and closing times of visit places, and whether hotel check-in/check-out times are compatible with movement events. Server adjusts start and end times within allowed tolerances, shifting events earlier or later, and may mark events as infeasible when constraints cannot be satisfied.

Output: A time-resolved schedule where each event has assigned start and end times that comply with movement and opening constraints, or flags indicating conflicts.

### Step 14:

Server computes total costs and applies budget constraints.

Server aggregates monetary values across all events and compares them against the user's budget.

Input: Structured travel plan data with precise fare amounts, lodging costs, and admission fees.

Data processing: Server sums all cost components to compute the total trip cost and may also compute per-day cost breakdowns; server compares the totals to the budget constraint; when the cost exceeds the budget, server identifies cost-intensive events and candidates for replacement or removal according to predefined cost-reduction rules.

Output: Structured travel plan data annotated with total cost values, daily costs, and indicators whether the budget constraint is satisfied or violated.

### Step 15:

Server adjusts the itinerary to resolve conflicts and budget violations.

Server modifies the selection and ordering of events in response to temporal conflicts and budget excess.

Input: Time-resolved structured travel plan data with conflict flags and budget comparison results.

Data processing: Server removes or moves events with lower priority, replaces costly facilities or routes with cheaper alternatives from previously obtained candidate lists, and, if necessary, uses an additional prompt sentence to request the generative AI model to propose alternative visit places or movement patterns within specified time and cost bounds. The server applies deterministic rules to accept or reject proposed alternatives based on updated constraints.

Output: An adjusted itinerary in which temporal conflicts are minimized or eliminated and total costs are within the budget constraints.

### Step 16:

Server finalizes the structured travel plan data and creates a digital information medium.

Server prepares both machine-readable and human-readable representations of the adjusted itinerary.

Input: Adjusted structured travel plan data with resolved times, locations, costs, and selected facilities.

Data processing: Server serializes the structured data into a standardized structured format for machine-readable consumption and generates a layout description for an electronic brochure, organizing events by day with separate sections for movement segments, lodging, and sightseeing; server embeds identifiers, textual descriptions, and cost summaries.

Output: A digital information medium including a machine-readable itinerary representation and a formatted brochure-style representation ready for transmission to the terminal.

### Step 17:

Server transmits the digital information medium to the terminal.

Server sends the prepared representations via the communication network to the requesting terminal.

Input: Digital information medium generated from the adjusted structured itinerary.

Data processing: Server packages the data into a response message, optionally compresses it, and transmits it using a network protocol; server records a plan identifier for later reference.

Output: A response message received by the terminal that contains the travel plan identifier and the digital information medium.

### Step 18:

Terminal displays the digital information medium to the user.

Terminal renders the human-readable representation as an interactive itinerary view.

Input: Digital information medium received from the server.

Data processing: Terminal parses the representation, builds UI components for each travel day and event, and displays structured sections for transportation, lodging, and sightseeing, including times and costs; terminal may generate interactive controls (for example, expansion panels, map links) to allow the user to inspect details.

Output: Visual presentation of the travel plan on the terminal screen, enabling the user to review and decide whether to proceed with reservations.

### Step 19:

User reviews the itinerary and issues a collective reservation request.

User examines the displayed plan and, if satisfied, selects an operation to reserve all included elements.

Input: Visual itinerary information displayed on the terminal.

Data processing: User mentally evaluates schedule and costs and chooses to confirm; user enters or confirms traveler information and payment authorization.

Output: A user command indicating collective reservation, along with traveler details and payment permission, which the terminal prepares to send to the server.

### Step 20:

Terminal assembles and transmits the reservation request.

Terminal packages the confirmed plan identifier, traveler information, and payment token into a structured request.

Input: User's collective reservation command, traveler details, payment token, and the plan identifier from the digital information medium.

Data processing: Terminal constructs a reservation request object containing references to the itinerary and user identity; terminal verifies completeness of mandatory data (for example, name, contact, payment token) and transmits the request to the server using a secure channel.

Output: A collective reservation request message delivered to the server.

### Step 21:

Server executes the collective reservation process with external systems.

Server reads the plan corresponding to the plan identifier and submits reservation requests to each external apparatus.

Input: Collective reservation request message including plan identifier, traveler data, and payment information.

Data processing: Server loads structured travel plan data from storage; server iterates through movement events, lodging events, and visit place events that require reservations; for each event, server composes reservation information (including resource identifier, time, traveler data, and payment token) and sends it to the appropriate external system; server receives responses indicating success or failure and records confirmation identifiers or failure codes.

Output: Updated structured travel plan data augmented with reservation results and a record of success or failure information for each element.

### Step 22:

Server handles reservation failures using alternative proposals.

Server reacts to failed reservations by searching for and integrating alternative elements.

Input: Reservation success or failure information tied to individual events in the structured travel plan data.

Data processing: Server applies rule-based logic to identify which failed elements can be replaced and with what constraints (for example, lower cost, different time slot, or nearby location). When needed, server generates an additional prompt sentence describing the failure and constraints (for example, “The originally selected hotel on Day 2 is unavailable; propose an alternative within 10% of the previous price and within walking distance of the same area”) and provides it to the generative AI model; server parses the model's response to extract candidate alternatives and re-applies the schedule and budget adjustment logic to integrate the alternatives; server then resubmits reservation information for the updated elements.

Output: A revised set of reservation results and an updated itinerary with alternative movement means, stay facilities, or visit places replacing failed elements.

### Step 23:

Server compiles final reservation confirmations and updates the digital information medium.

Server consolidates all reservation confirmations and regenerates the itinerary representation.

Input: Structured travel plan data containing successful reservation identifiers, any remaining failures, and the final schedule and cost structure.

Data processing: Server assembles all reservation numbers, ticket references, and QR code data into the itinerary; server regenerates the human-readable brochure representation to include confirmation details and final prices; server may also generate machine-readable ticket or calendar attachments linked to each event.

Output: A finalized digital information medium that includes confirmed reservations, updated costs, and digital ticket information.

### Step 24:

Server transmits final confirmation data to the terminal.

Server returns the finalized itinerary and status of all reservations.

Input: Finalized digital information medium and overall booking status (for example, “complete” or “partial with warnings”).

Data processing: Server constructs a response message containing the updated medium, overall status, and any notification messages (for example, unavailable activities); server transmits this message to the terminal.

Output: Confirmation message received by the terminal, enabling display of the final booked plan.

### Step 25:

Terminal displays the final booked plan and associated credentials to the user.

Terminal presents all reservation details in an organized format.

Input: Final confirmation message and updated digital information medium from the server.

Data processing: Terminal parses the message, updates on-screen information to reflect confirmed reservations, displays reservation numbers and QR codes where applicable, and may provide options to export entries to calendar or passbook-type applications using device-specific APIs.

Output: A complete, booked itinerary visible on the terminal, enabling the user to access all technical details necessary to execute the trip.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented planning systems for travel, logistics, and other service aggregation tasks typically follow a rigid, rule-based architecture. A processor receives user input, applies predetermined filters and scoring rules, and outputs an itinerary or supply plan. Such systems exhibit several technical limitations.

First, these systems are not designed to flexibly integrate heterogeneous data types, such as structured user constraints, unstructured natural-language preferences, and emotion-related data captured from user interfaces or sensors. As a result, the processor must perform multiple disjoint processing paths and ad hoc mappings, which increases processing complexity, leads to inefficient use of memory and CPU resources, and often requires repeated user interaction to refine plans.

Second, conventional systems do not generate or manage machine-readable prompt sentences as first-class internal artifacts for interaction with a generative AI model. Instead, any interaction with an external model, if present, is typically limited to sending raw user text.

This prevents the processor from systematically combining structured constraints, extracted semantic features, and inferred emotional states into a single optimized query. Consequently, the system cannot effectively leverage generative models to compute globally consistent plans that respect both hard constraints (schedule, budget, capacity) and soft constraints (user mood, qualitative preferences).

Third, known planning systems often separate plan generation from reservation or ordering execution. The itinerary or supply plan is computed in one module, while reservation or order submission is handled later by a separate workflow, often requiring manual re-entry or mapping of data. This fragmented architecture causes additional latency, increases the number of network transactions, and raises the risk of inconsistency between a proposed plan and actual reservations, especially when dealing with multiple external reservation or ordering services.

Fourth, conventional user interfaces typically present static lists of options without embedding machine-interpretable metadata that reflects emotion-aware attributes or bulk-execution capabilities. The processor must repeatedly recompute or translate user selections to back-end calls, which leads to redundant computations and increased load on both the local system and external services. This also prevents efficient batch scheduling of network requests and limits scalability when many users request complex multi-component plans.

Accordingly, there is a need for a computer-implemented system and server-side architecture that (i) systematically converts user inputs into structured data, (ii) integrates emotion estimation, semantic analysis, and candidate service extraction into a unified processing pipeline, (iii) generates and uses optimized prompt sentences to control a generative AI model for plan generation, (iv) constructs digital guidance information embedding machine-interpretable plan structure and emotion attributes, and (v) directly drives bulk reservation or bulk ordering to external services from the generated plan. Such a system should improve computational efficiency, reduce redundant data transformations, and enhance the technical functioning of the server and networked environment when generating and executing complex, constraint-aware plans.

The specific processing by the specific processing unit 290 of the data processing device 12 in Application Example 2 is realized by the following means.

The present invention provides a server comprising a processor configured to acquire, via a terminal, user condition information and preference information, convert the acquired information into structured data, extract candidate service information based on the structured data, estimate a user emotional state from input information or emotion-related data, generate emotion information representing the emotional state, generate a prompt sentence that instructs a generative AI model to generate plan information based on the structured data and the emotion information, input the prompt sentence and the candidate service information into the generative AI model and obtain, from the generative AI model, plan information including at least one of a travel plan or a supply plan, analyze the plan information and generate integrated plan data including at least schedule information, location information, cost information, and service content information while verifying conformity with predetermined constraint conditions, generate digital guidance information including the integrated plan data, the schedule information, the location information, description information, and an operation element for performing bulk reservation or bulk ordering, transmit the digital guidance information to the terminal for presentation to the user, and, in response to a bulk reservation operation or a bulk ordering operation on the digital guidance information, communicate with at least one external reservation device or external ordering device to perform bulk reservation or bulk ordering for a plurality of services or supplies. This enables the server to implement an integrated, technically efficient pipeline in which heterogeneous user inputs and emotion-related data are normalized into structured representations, converted into optimized prompt sentences for a generative AI model, and automatically transformed into machine-interpretable digital guidance information that directly drives coordinated bulk reservation or ordering transactions, thereby reducing computational overhead, minimizing redundant data conversions, and improving the overall performance and scalability of computer-implemented planning and execution processes.

The term “processor” refers to a hardware processing unit or a combination of hardware and executable software that performs arithmetic, logic, control, and data processing operations to execute instructions implementing the functions of the claimed system.

The term “terminal” refers to an electronic device operated by a user, including at least a display unit, an input unit, and a communication unit, and configured to transmit user input information to a server and to present digital information received from the server.

The term “user” refers to a human operator or an entity that provides input information via a terminal and receives and interacts with digital information generated by the system.

The term “condition information” refers to information specifying objective constraints or requirements provided by the user, including at least one of time, date, duration, budget, location, quantity, or category of a desired service or supply.

The term “preference information” refers to information representing subjective or qualitative desires of the user, including at least one of desired activity type, ambiance, style, or priority among cost, comfort, speed, or other qualitative aspects.

The term “structured data” refers to data represented in a standardized format with explicit fields and relationships, such as tabular, record-based, or key-value formats, enabling programmatic analysis, filtering, and transformation.

The term “candidate service information” refers to information relating to one or more potential services or supplies that may be included in a plan, including at least identifiers, locations, availability, costs, categories, and other attributes suitable for selection or recommendation.

The term “input information” refers to information received by the system from the terminal or from other devices, including at least user-provided text, form entries, selections, and sensor-derived data.

The term “emotion-related data” refers to data used to infer a user's emotional state, including at least one of image data, audio data, biometric data, interaction patterns, or text expressing feelings, captured by a sensor or interface.

The term “emotion acquisition device” refers to a hardware component or a combination of hardware and software, such as a camera, microphone, or sensor module, configured to acquire emotion-related data associated with the user.

The term “emotional state” refers to a psychological condition of the user inferred from emotion-related data or input information, including at least one of relaxation, excitement, stress, or a desire for activity or calmness.

The term “emotion information” refers to data representing an estimated emotional state of the user, including at least a label of the emotional state and optionally a confidence value or intensity value associated with the state.

The term “generative AI model” refers to a machine-implemented model trained on data to generate new content or predictions, configured to output plan information, text, or structured data in response to an input prompt.

The term “prompt sentence” refers to a text sequence or data structure that encodes instructions, context, and constraints for the generative AI model, and that is used to cause the generative AI model to generate plan information.

The term “plan information” refers to information output by the generative AI model in response to a prompt sentence, including at least one of a travel plan, a supply plan, or a combination of service selections, schedules, and descriptions.

The term “travel plan” refers to a plan including at least one of schedule information, transportation information, accommodation information, sightseeing information, and associated costs for a travel scenario.

The term “supply plan” refers to a plan including at least one of supply source information, supply item information, timing information, and associated costs for providing goods or services to the user.

The term “constraint conditions” refers to rules or limits that plan information must satisfy, including at least one of budget limits, time windows, capacity limits, location constraints, or logical consistency constraints.

The term “integrated plan data” refers to data obtained by combining, organizing, and validating plan information with respect to constraint conditions, and including at least schedule information, location information, cost information, and service content information in a coherent structure.

The term “schedule information” refers to data describing times or periods associated with planned services or supplies, including at least start times, end times, dates, and temporal order of events.

The term “location information” refers to data indicating geographical positions or places associated with services or supplies, including at least addresses, coordinates, or identifiable location names.

The term “service content” refers to details describing the nature of a service or supply, including at least type, description, options, and quality attributes.

The term “digital guidance information” refers to electronic information generated for presentation on a terminal, including integrated plan data, schedule information, location information, descriptive text, and one or more operation elements for user interaction.

The term “operation element” refers to a user-selectable interface component, such as a button, link, or control, included in digital guidance information and configured to trigger a process such as bulk reservation or bulk ordering.

The term “bulk reservation” refers to a process in which requests for reservation of two or more services, including at least one of transportation, accommodation, or activity, are executed together in response to a single user operation.

The term “bulk ordering” refers to a process in which orders for two or more supplies or services are executed together in response to a single user operation.

The term “external reservation device” refers to a computer system or service, accessible via a communication network, that receives reservation requests and returns reservation confirmations for services such as transportation, accommodation, or activities.

The term “external ordering device” refers to a computer system or service, accessible via a communication network, that receives ordering requests and returns order confirmations for goods or services.

The term “digital tour pamphlet” refers to a specific form of digital guidance information for travel, including at least an itinerary representation, location information, descriptive content, and reservation-related operation elements.

The term “digital guidance document” refers to a specific form of digital guidance information for supply or service scenarios, including at least supply source information, supply content information, timing information, and bulk ordering-related operation elements.

The term “emotion attribute” refers to metadata associated with an item in digital guidance information, indicating that the item is related to a particular emotional state, such as relaxation, activity, or calmness.

The term “display data” refers to data formatted for rendering by a user interface on a terminal, derived from digital guidance information and including layout, labels, and interaction elements for presentation.

The term “communication function” refers to a capability of a device or system to exchange data with another device or system via a wired or wireless communication network, using one or more communication protocols.

The term “services” refers to actions or activities provided to the user, including at least transportation services, accommodation services, sightseeing services, dining services, or other user-facing service offerings.

The term “supplies” refers to goods, products, or deliverable items provided to the user, including at least consumable goods, packaged items, or other tangible or intangible deliverables.

In one embodiment, a server, a terminal, and a communication network cooperate to implement the claimed system. The server includes at least one processor, a main memory, a non-volatile storage device, and a network interface. The terminal includes a display unit, an input unit such as a touch panel, a camera and/or microphone as an emotion acquisition device, a local processor, a memory, and a wireless or wired communication interface. The server and the terminal communicate over a communication network such as the Internet using secure transport protocols.

The server executes an application program implemented, for example, in a general-purpose programming language. The application program is composed of multiple software modules including an input reception module, a data structuring module, a feature extraction module, an emotion estimation module, a prompt generation module, a generative-model interface module, a plan integration module, a digital guidance generation module, and a bulk reservation/ordering module. The terminal executes a user-interface program, for example implemented by a cross-platform framework, that presents screens, acquires user input, acquires emotion-related data via the camera or microphone, and exchanges messages with the server.

The terminal acquires condition information and preference information from a user. The terminal presents one or more input screens that include fields for dates, locations, budget, number of persons, desired categories of services or supplies, and natural-language preference text. The terminal also acquires emotion-related data such as facial images or voice samples from the user, after obtaining consent, by activating the camera or microphone.

The terminal converts the user's input into a structured message comprising key-value pairs and attaches metadata such as a terminal identifier, a timestamp, and optionally low-level emotion cues (for example, facial landmark coordinates). The terminal transmits this structured message to the server via the network interface.

The server receives the structured message and temporarily stores it in the memory. The server uses a data structuring module implemented, for example, with a tabular data library to convert the received key-value pairs into structured data records. The server stores the structured data records in a persistent storage device such as a relational database management system. The server normalizes the values, for example, by converting textual dates into internal timestamp representations, converting currency strings into numeric budget values in a standard currency unit, and mapping natural-language travel durations such as “3 nights, 4 days” to start and end timestamps. By storing data in normalized, typed columns, the server later performs vectorized computations more efficiently than with free-form text.

The server uses a feature extraction module to generate feature vectors from the structured data. The server maps categorical fields such as destination city, service type, or cuisine type to numerical indices and then to embedding vectors. The server derives numerical features from budget ranges, travel durations, and distances between locations. The server may use a machine-learning library to perform scaling, normalization, and dimensionality reduction on these features. In addition, the server uses a natural-language processing library to process preference text supplied by the user. The server performs tokenization, part-of-speech tagging, and named entity recognition to extract entities such as specific attractions, neighborhoods, or qualitative attributes such as “quiet,” “luxury,” or “family-friendly.” The server encodes these results into additional feature dimensions, such as binary flags or continuous scores.

The server also estimates the user's emotional state. The server receives emotion-related data from the terminal, such as facial images or voice features. The server uses the emotion estimation module, which internally executes a trained neural network model, to classify the emotional state. In one embodiment, the server loads a convolutional neural network that receives as input an image tensor representing a user's face. The network includes a plurality of convolutional layers, pooling layers, and fully connected layers, with learned weight parameters stored in the storage device. The network has been trained on a large dataset of labeled facial expressions. During training, the server used a supervised learning procedure with a cross-entropy loss function, an optimization algorithm such as stochastic gradient descent or Adam, and regularization techniques such as dropout and data augmentation (for example, random cropping, flipping, and brightness changes). The server updates the network weights to minimize the loss over many training epochs, thereby enabling robust emotion classification.

In operation, the server forwards the preprocessed image to the neural network, obtains an output probability vector over emotion classes such as “relaxed,” “excited,” “stressed,” and “bored,” and selects the dominant class as the emotional state. The server may also compute a confidence score. The server stores the emotional state and confidence score in the relational database and attaches this emotion information to the structured record for the corresponding user request. In another embodiment, the server uses a recurrent or transformer-based neural network to estimate emotion from speech features, where the server extracts Mel-frequency cepstral coefficients or other acoustic features and feeds them into the network. The same training and inference principles apply.

The server uses the structured data, the feature vectors, and the emotion information to select candidate service information. The server maintains in the storage device one or more large tables of service options, such as transportation options, accommodations, sightseeing spots, dining facilities, or supply sources. Each record in these tables includes identifiers, coordinates, price ranges, time windows, categories, ratings, and other attributes. The server uses vectorized queries to filter these tables according to hard constraints such as budget, date ranges, capacity, and distance from the requested location. The server may apply additional ranking models, for example gradient-boosted trees or linear models, to score candidate services according to relevance, predicted satisfaction, or fit with emotion attributes. The server extracts a subset of candidate services, represented by identifiers and key attributes, and stores this subset in the memory as candidate service information.

The server then generates a prompt sentence for a generative AI model. The server's prompt generation module constructs a textual description that includes the user's structured conditions, the inferred emotion, and summaries of candidate services. The prompt generation module uses a template-based approach combined with dynamic insertion of data values. For example, the server can generate the following prompt sentence:

“The user wants a 3-night, 4-day trip from Tokyo to Kyoto with a budget of 100,000 yen. The user's emotional state is ‘relaxed’ and the user wants to rest. Using the following list of candidate hotels and sightseeing spots, propose a detailed day-by-day travel plan that focuses on quiet, relaxing activities and calm accommodations. Output a structured itinerary with dates, times, locations, brief descriptions, and reasons why each element is relaxing.”

In a supply scenario, the server can generate the following prompt sentence:

“The user input is ‘a dinner set under 3,000 yen that arrives within 30 minutes’. Based on the following candidate restaurants and menus, propose one or more optimal restaurant and menu combinations that satisfy the budget and time constraints and briefly explain why they are suitable.”

The server may apply additional rules when constructing the prompt sentence, such as always including explicit instruction about output format (for example, list format or day-by-day schedule) or about respecting constraint conditions. By structuring the prompt sentence in this non-conventional, constraint-aware form, the server improves the reliability and determinism of the subsequent plan generation.

The server interfaces with a generative AI model via a generative-model interface module.

The server transmits the prompt sentence and optionally the candidate service information to the generative AI model using an application programming interface. The generative AI model is, for example, a transformer-based neural network comprising multiple layers of self-attention and feed-forward sub-layers, with parameters learned from large-scale text and planning data. During its training phase, the generative AI model has been optimized by minimizing a sequence-prediction loss function such as cross-entropy over training examples of text descriptions and plans. The model uses positional encodings, multi-head attention, and layer normalization to capture long-range dependencies and to stabilize training.

At inference time, the server transmits the prompt sentence to the generative AI model, which computes hidden representations through its stacked attention layers, and generates a sequence of output tokens that describe a travel plan or supply plan. The generative AI model internally computes attention scores between the prompt and the generated tokens, thereby aligning constraints in the prompt sentence with plan items in the output. The server receives the output text as plan information. In some embodiments, the server constrains the generative process by specifying decoding parameters such as temperature, top-k or top-p sampling thresholds, or maximum token counts so as to control diversity and length of the generated plan.

The server does not treat the plan information merely as free-form text. The server uses the plan integration module to parse and validate the plan information. The server applies a combination of pattern-matching rules and natural-language parsing to identify schedule segments, dates, times, locations, and service names in the generated plan. The server maps generated names to actual service identifiers in the service tables by a fuzzy matching or embedding-based similarity search, and discards or corrects any unmatched items. The server compares the total estimated cost of the proposed plan, computed from current prices in the service tables, against the user's budget. The server also checks the temporal consistency of the schedule, for example, ensuring that no two services overlap in time and that travel times between locations are sufficient. If violations of constraint conditions are detected, the server automatically adjusts the plan by substituting alternative services or by shifting time slots, based on a set of deterministic rules and optimization heuristics.

The server produces integrated plan data as a result of this validation and correction. The integrated plan data is a machine-readable structure that includes, for each planned item, a date, a start time, an end time, a location identifier, a service identifier, a cost, and one or more emotion attributes. The server stores the integrated plan data in the relational database and caches it in memory. By converting the generative output into this well-defined structure, the server enables efficient downstream operations such as sorting, filtering, and reservation mapping, and reduces the need for repeated parsing.

The server generates digital guidance information from the integrated plan data. The server selects layout templates and populates them with schedule information, location information, and descriptions of each plan item. The server embeds operation elements such as buttons or links associated with each service or each group of services. The server also adds emotion attributes to visual indicators, for example, marking items that are “relaxing” or “highly active” with corresponding tags or colors. The server produces view-specific data structures (for example, hierarchical JSON objects or markup documents) tailored to the user interface framework running on the terminal. By pre-assembling this digital guidance information on the server side, the system reduces the amount of client-side computation and simplifies the mapping between interface elements and underlying plan items.

The terminal receives the digital guidance information and renders it on the display unit. The terminal presents an itinerary view for travel plans or a list view for supply plans. The terminal renders operation elements such as a “Reserve all” button or an “Order all” button.

The terminal maintains a mapping between these operation elements and plan item identifiers supplied by the server. When the user activates a bulk reservation or bulk ordering operation, the terminal sends a compact instruction message including plan identifiers and selected options back to the server.

The server executes bulk reservation or bulk ordering in response to the user's operation. The server uses an external-services integration module to communicate with multiple external reservation devices or external ordering devices through their respective application programming interfaces. For each plan item, the server constructs a request message that includes necessary parameters such as service identifier, date, time, quantity, and user credentials or payment tokens. The server schedules these external calls in batches, according to the structure of the integrated plan data, rather than executing them in an ad hoc, step-by-step manner. By batching requests and using asynchronous, non-blocking communication, the server reduces network round-trip overhead and improves throughput.

Once confirmations or error codes are received from the external devices, the server aggregates confirmation information, associates it with the corresponding plan items, and updates the database. The server then notifies the terminal, which updates the user interface to display confirmed reservations or orders.

The described architecture provides technical improvements over conventional systems. Because the server converts heterogeneous inputs into normalized structured data and feature vectors before interacting with the generative AI model, the server can exploit vectorized operations and indexed queries, which reduce computation time and memory usage compared with repeatedly processing raw text. The integration of emotion information as explicit features leads to more accurate selection of candidate services and more targeted prompt sentences, which, in turn, reduce the number of iterations required to obtain an acceptable plan. The system's use of a constraint-aware prompt sentence and subsequent validation and correction of the generative output mitigates the risk of inconsistent or infeasible plans, thereby lowering the error rate of reservations and decreasing the need for manual corrections.

The use of a transformer-based generative AI model is not a mere automation of human judgment. The model processes high-dimensional embeddings and long-range dependencies that a human planner cannot feasibly compute in real time. The server uses attention-based neural inference and structured post-processing to coordinate dozens or hundreds of candidate services subject to multiple hard and soft constraints. The internal optimization procedures, including loss-function-driven weight updates, regularization, and data augmentation during training, yield a model that generalizes across diverse planning contexts, further improving performance and robustness.

The system also improves data management and communication efficiency. The integrated plan data and digital guidance information are structured so that the server issues minimal, targeted queries to external devices, and the terminal receives only the information needed for rendering and control. The bulk reservation mechanism, orchestrated by the server based on integrated plan data, reduces the number of user interactions and network messages compared with sequential manual booking. This design yields lower latency and reduced load on both the server and external services.

Multiple variations are possible within this framework. In another embodiment, the server uses a different type of generative AI model such as a sequence-to-sequence recurrent neural network with attention, or a hybrid model that combines symbolic constraints with neural generation. In another embodiment, the emotion estimation module uses text-based sentiment analysis instead of or in addition to image-based facial analysis. In yet another embodiment, the server selects candidate services from non-relational data stores, such as document databases or graph databases, while preserving the structured integrated plan data format. The server may also adapt the level of detail in the prompt sentence and the digital guidance information depending on user expertise or device capabilities.

In all of these embodiments, the server, the terminal, and the associated software modules implement specific data structures, neural architectures, and processing flows that enhance computational efficiency, accuracy, and scalability compared with conventional rule-based or manually driven planning systems. The combination of structured data transformation, emotion-aware feature extraction, optimized prompt sentence generation for a generative AI model, and integrated bulk reservation or ordering directly from machine-interpretable plan structures provides a concrete improvement to computer technology in the field of automated planning and service orchestration.

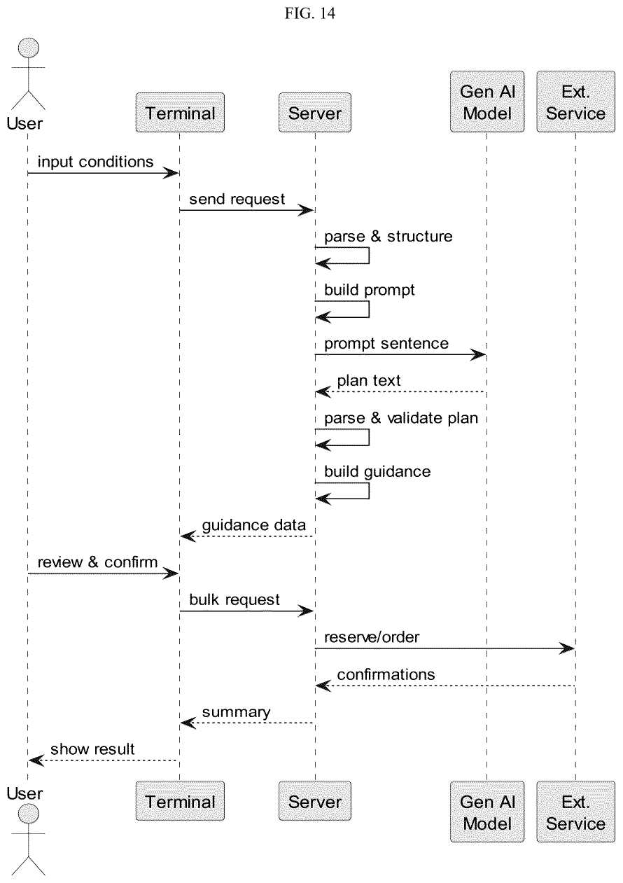

The following describes the processing flow using FIG. 14.

### Step 1:

The user operates the terminal and inputs condition information and preference information.

The user enters, for example, departure location, destination, dates, budget, number of persons, desired service categories, and free-text preferences such as “I want a quiet onsen and a traditional inn.” The input of this step is raw user interaction data (form fields and free-text entries). The output of this step is a set of validated input values temporarily stored in the terminal's memory.

### Step 2:

The terminal converts the validated input values into a structured message. The terminal maps each field to a key (for example, “origin,” “destination,” “start_date,” “end_date,” “budget,” “preference_text”) and serializes the values into a structured format. The input of this step is the user's validated form input. The output of this step is a structured user request object that can be transmitted to the server.

### Step 3:

The terminal optionally acquires emotion-related data from an emotion acquisition device.

The terminal activates a camera or microphone, captures facial images or voice segments, and, if configured, computes low-level features such as facial landmark coordinates or audio descriptors. The input of this step is sensor signals from the emotion acquisition device. The output of this step is emotion-related data attached to the structured user request object.

### Step 4:

The terminal transmits the structured user request object, including condition information, preference information, and optional emotion-related data, to the server via a communication network. The terminal uses a network protocol to send the data to a predefined server endpoint. The input of this step is the assembled user request object. The output of this step is a network message delivered to the server.

### Step 5:

The server receives the network message and parses the structured user request object. The server verifies the message format, extracts fields such as dates, locations, budget, and preference text, and writes the raw request into a persistent storage device. The input of this step is the serialized request object received from the terminal. The output of this step is a normalized internal representation of the request stored in memory and in a database.

### Step 6:

The server converts the normalized request into structured data records. The server uses a tabular-data module to construct a record or row with typed columns, for example, mapping date strings to timestamp fields, currency strings to numeric budget fields, and location names to standardized location identifiers. The input of this step is the parsed request representation. The output of this step is structured data suitable for further feature extraction.

### Step 7:

The server extracts numerical and categorical features from the structured data. The server transforms categorical fields (such as “travel_purpose” or “service_category”) into indices or one-hot vectors, computes numerical features such as duration in hours or days from start and end timestamps, and normalizes budget values to a standard range. The input of this step is the structured data record. The output of this step is a feature vector representing the user's objective constraints.

### Step 8:

The server performs natural-language processing on the preference text. The server tokenizes the text, detects parts of speech, and identifies named entities such as city names, landmarks, and qualitative descriptors (“quiet,” “luxury,” “adventure”). The server then maps these entities to structured flags or scores (for example, “preference_relaxation=1,” “preference_nightlife=0”). The input of this step is the raw preference text string. The output of this step is a set of semantic features that capture the user's subjective preferences.

### Step 9:

The server estimates the user's emotional state from the emotion-related data, if available.

The server feeds image or audio features into a trained neural network model for emotion classification, computes a probability distribution over emotion classes, and selects the most probable class as the emotional state. The input of this step is the emotion-related data uploaded from the terminal. The output of this step is emotion information including an emotion label (for example, “relaxed” or “excited”) and a confidence value.

### Step 10:

The server aggregates the constraint features, semantic preference features, and emotion information into a unified feature representation. The server concatenates numerical vectors, merges flags, and stores the combined feature vector with the user request record. The input of this step is the feature vector from objective constraints, the semantic features, and the emotion information. The output of this step is a comprehensive feature representation that describes both hard and soft conditions of the request.

### Step 11:

The server selects candidate service information from internal service data stores. The server queries one or more service tables (for example, transportation, accommodations, sightseeing spots, dining facilities, or supply sources) using the aggregated features to filter by budget, dates, capacity, location proximity, and category. The server may rank candidates using scoring functions or machine-learning models. The input of this step is the aggregated feature representation and the service master data. The output of this step is a set of candidate services with identifiers and attributes.

### Step 12:

The server constructs a prompt sentence for a generative AI model based on the aggregated features and the candidate service information. The server inserts values such as dates, locations, budget, emotional state, and brief summaries of candidate services into predetermined sentence templates. The input of this step is the aggregated feature representation and the candidate service list. The output of this step is a constraint-aware prompt sentence that specifies the planning task.

### Step 13:

The server refines the prompt sentence with output-format instructions to guide the generative AI model. The server appends directives such as “output a day-by-day itinerary with times, locations, and reasons matching the emotional state” or “output a list of restaurant and menu combinations that satisfy budget and time constraints.” The input of this step is the initial prompt sentence from the previous step. The output of this step is a final prompt sentence suitable for reliable plan generation.

### Step 14:

The server sends the final prompt sentence and relevant candidate service information to the generative AI model through a generative-model interface. The server forms a request that includes the prompt sentence as model input and may include structured candidate lists as context. The input of this step is the final prompt sentence and optional structured context.

The output of this step is a model-ready request transmitted to the generative AI model.

### Step 15:

The server receives plan information output by the generative AI model. The generative AI model processes the prompt sentence and returns a generated text sequence that describes a travel plan or supply plan with specific items, schedules, and explanations. The input of this step is the model's response message. The output of this step is a raw textual description of plan information held in the server's memory.

### Step 16:

The server parses the raw plan information to extract structured plan items. The server applies pattern-matching rules and natural-language parsers to identify dates, time slots, location names, and service names within the generated text. The server converts each detected item into a structured entry containing fields such as date, start time, end time, location, and service description. The input of this step is the raw plan text from the generative AI model. The output of this step is an initial structured plan dataset.

### Step 17:

The server maps generated service descriptions to actual service records in the internal service data stores. The server uses string similarity, embeddings, or identifier tags included in the generative output to align generated items with concrete service entries. The server discards unmatched items or replaces them with close alternatives. The input of this step is the initial structured plan dataset and the service master data. The output of this step is a refined plan dataset with valid service identifiers.

### Step 18:

The server verifies constraint conditions for the refined plan dataset. The server calculates total cost by summing the prices of selected services, checks whether the cost is within the budget, computes travel times between locations, and checks for overlapping time slots or impossible transitions. The server flags any violations and applies correction rules, such as substituting a lower-cost service or shifting an activity to a different time slot. The input of this step is the refined plan dataset and the original constraint features. The output of this step is an integrated plan dataset that satisfies the predetermined constraint conditions.

### Step 19:

The server attaches emotion attributes to plan items based on the emotion information and the characteristics of selected services. The server labels each item with attributes such as “relaxing,” “active,” or “calm,” depending on both the emotion label and metadata about the service (for example, a spa is labeled relaxing). The input of this step is the integrated plan dataset and the emotion information. The output of this step is integrated plan data enriched with emotion attributes for each item.

### Step 20:

The server generates digital guidance information from the integrated plan data. The server selects layout templates and populates structures for schedules, locations, descriptions, costs, and emotion tags. The server also defines operation elements, such as a bulk reservation button associated with all services or a bulk ordering button associated with all supply items.

The input of this step is the emotion-enriched integrated plan data. The output of this step is a digital guidance data structure ready for transmission to the terminal.

### Step 21:

The server transmits the digital guidance information to the terminal for presentation to the user. The server serializes the guidance structure into a suitable format and sends it over the network interface. The input of this step is the digital guidance data structure. The output of this step is a network message containing the plan and user-interface metadata.

### Step 22:

The terminal receives the digital guidance information and renders it on the display unit. The terminal interprets schedule entries, locations, descriptions, and emotion tags, and generates visual components such as day-by-day itinerary views or lists of recommended supplies. The terminal binds operation elements, such as the bulk reservation or bulk ordering buttons, to internal handlers that reference the plan item identifiers. The input of this step is the serialized digital guidance information from the server. The output of this step is a visual presentation of the plan and interactive controls on the terminal.

### Step 23:

The user reviews the presented digital guidance information and selects whether to perform bulk reservation or bulk ordering. The user may inspect details of individual items, expand sections, or scroll through the schedule before choosing an action. The input of this step is the rendered user interface on the terminal. The output of this step is a user interaction event indicating acceptance or rejection of the plan, or selection of specific items.

### Step 24:

The terminal generates a bulk operation request when the user activates a bulk reservation or bulk ordering control. The terminal collects plan identifiers and option settings (for example, number of persons or quantity of items), compresses them into a compact message, and sends the message to the server. The input of this step is the user's bulk operation interaction. The output of this step is a structured bulk operation request transmitted to the server.

### Step 25:

The server receives the bulk operation request and prepares calls to external reservation devices or external ordering devices. The server looks up the corresponding services or supplies in the integrated plan data, groups them when possible by provider, and constructs request payloads for each external system. The input of this step is the structured bulk operation request and the stored integrated plan data. The output of this step is a sequence or batch of outgoing reservation or ordering requests.

### Step 26:

The server sends the reservation or ordering requests to external systems and waits for responses. The server uses asynchronous network calls to transmit each request, monitors completion states, and records immediate confirmation numbers or error codes. The input of this step is the prepared reservation or ordering payloads. The output of this step is a collection of confirmation messages or failure notifications from external systems.

### Step 27:

The server aggregates the responses from external systems and updates the integrated plan data accordingly. The server matches each confirmation message to the associated plan item, stores reservation identifiers or order identifiers in the database, and updates status fields such as “confirmed,” “pending,” or “failed.” The input of this step is the set of confirmation messages from external devices. The output of this step is an updated integrated plan dataset reflecting final reservation or ordering states.

### Step 28:

The server generates a confirmation summary and transmits it to the terminal. The server compiles confirmation identifiers, scheduled times, and locations into a compact summary structure linked to the original digital guidance context. The input of this step is the updated integrated plan dataset. The output of this step is a confirmation message that describes the results of the bulk reservation or bulk ordering.

### Step 29:

The terminal receives the confirmation summary and updates the displayed information. The terminal presents reservation numbers, order tracking identifiers, and status indicators for each item in the plan, and may provide options to save, print, or share the confirmation. The input of this step is the confirmation message from the server. The output of this step is a finalized presentation of confirmed reservations or orders to the user.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

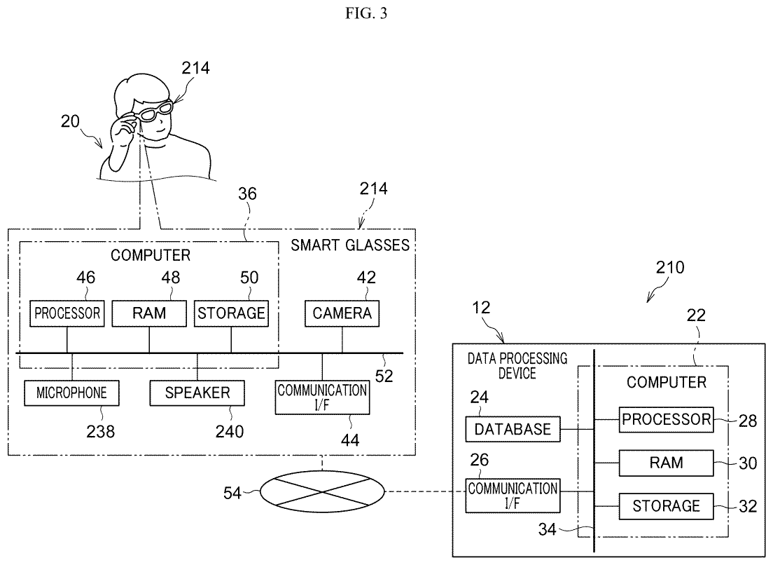

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

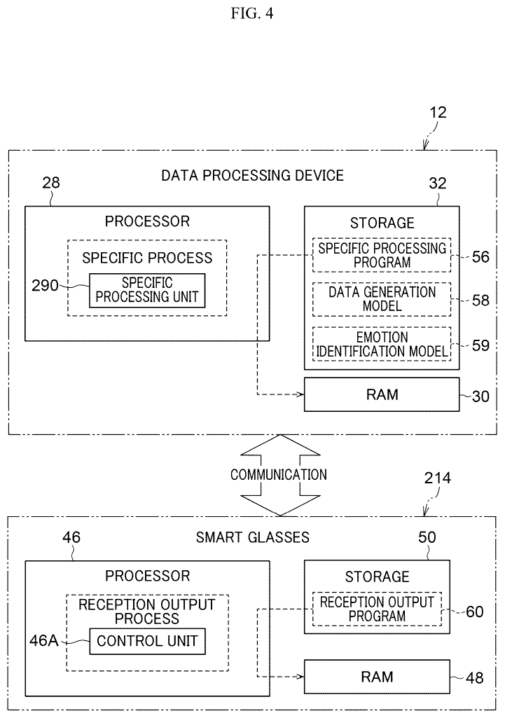

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

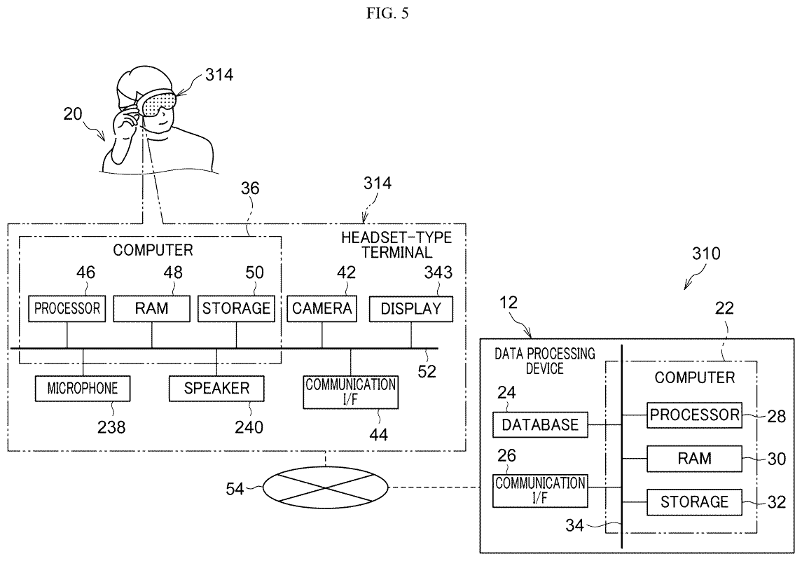

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

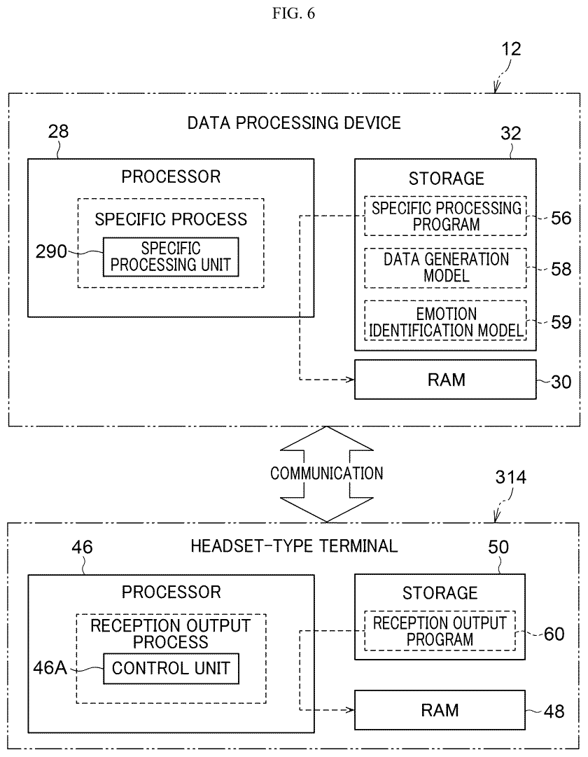

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

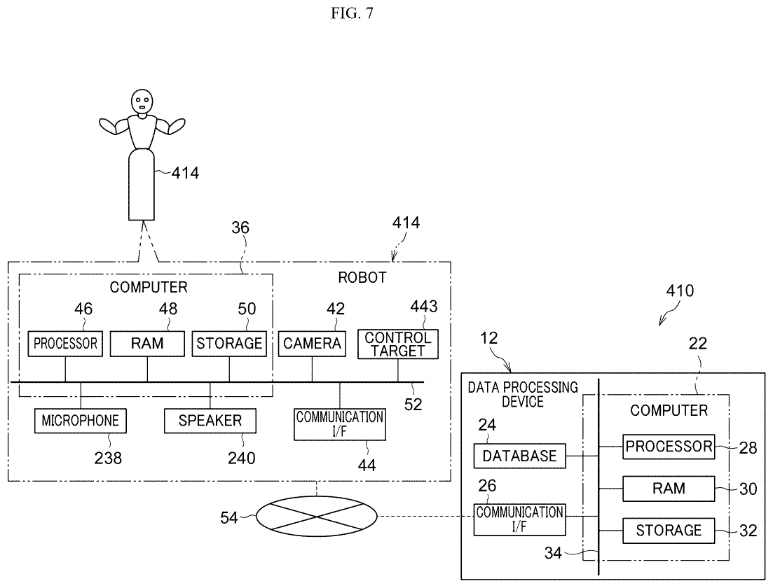

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

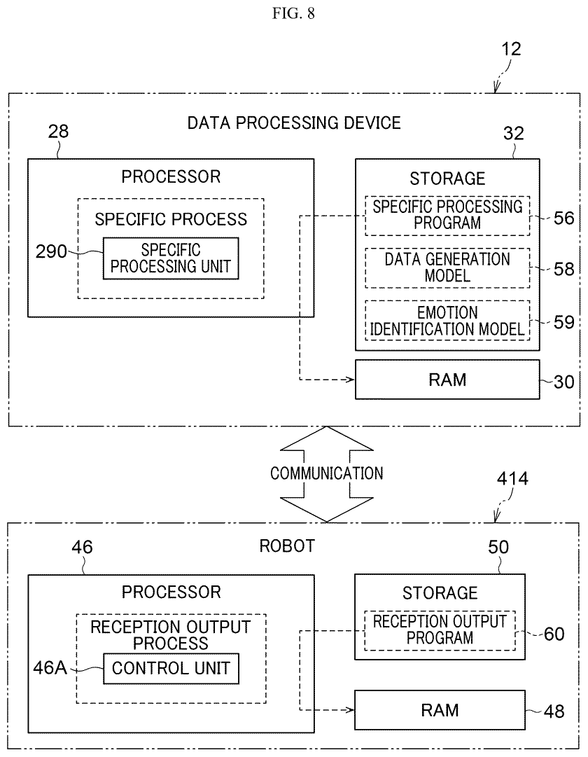

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

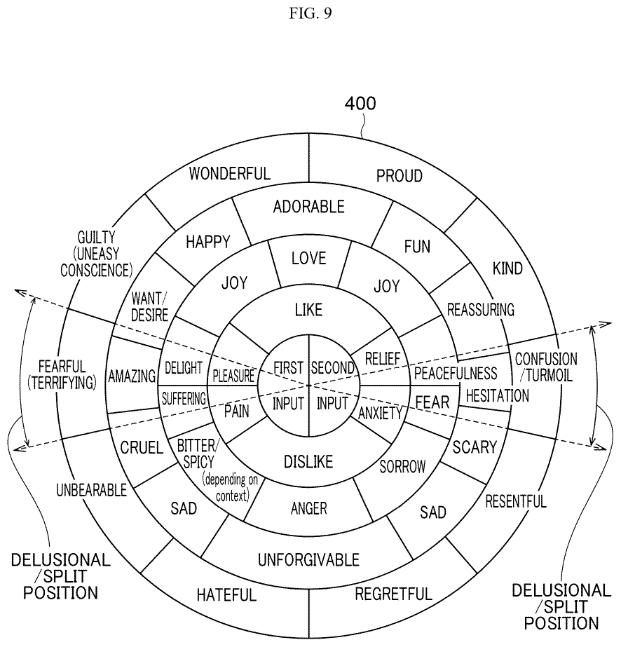

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University).

Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

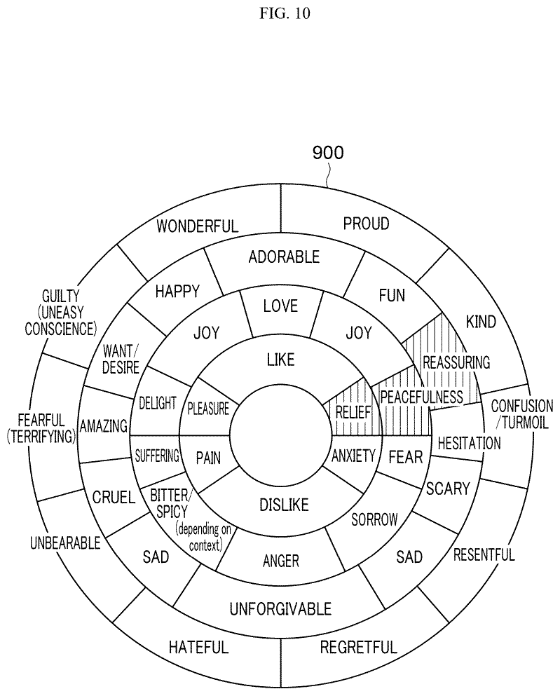

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
acquire input information from a user, the input information including at least a target region,
an implementation period, and an upper expenditure limit, by using an information acquisition unit, and
obtain reference information from an information storage unit storing past information and trend information, and generate a prompt sentence for input to a generative information processing model by using the input information and the reference information by using a prompt generation unit, and
input the prompt sentence generated by the prompt generation unit into the generative information processing model and cause the generative information processing model to generate behavior plan data, the behavior plan data including at least activity elements, movement means, staying facilities, and cost information that conform to the implementation period and the upper expenditure limit, by using a behavior plan generation unit, and
analyze the behavior plan data generated by the behavior plan generation unit, verify the activity elements, the movement means, the staying facilities, and the cost information, and
determine consistency with the upper expenditure limit and temporal consistency with the implementation period by using a plan verification unit, and
convert the behavior plan data verified by the plan verification unit into guide information for an electronic medium, the guide information including at least time-series information, position information, cost information, and visual configuration information, by using a guide information generation unit, and
transmit the guide information for the electronic medium generated by the guide information generation unit, as display image data or structured data, to a terminal device and provide the guide information in a format visually presentable on the terminal device by using a guide information providing unit, and
execute, in response to a behavior plan selected by the user on the basis of the guide information for the electronic medium provided by the guide information providing unit, a plurality of reservation processes in batch regarding at least a schedule, movement means, and staying facilities, through communication with an external reservation device, by using a reservation processing unit.

### Supplementary 2

The system according to supplementary 1,
wherein the processor is configured to
cause the guide information generation unit to structure the behavior plan data as the guide information for the electronic medium including at least a list of activities on a daily basis or a time-zone basis, attribute information of the staying facilities, time information of the movement means, and breakdown information of the costs together with layout information, and cause the guide information providing unit to provide the structured guide information for the electronic medium to the terminal device in a digital tour brochure format.

### Supplementary 3

The system according to supplementary 1,
wherein the processor is configured to
cause the reservation processing unit to generate, on the basis of the behavior plan data, request data for external reservation devices corresponding to each of the activity elements, each of the movement means, and each of the staying facilities, to communicate with a plurality of the external reservation devices by using the request data, to integrate reservation results acquired from the plurality of the external reservation devices, to generate reservation confirmation information including reservation identification information and total cost information, and to transmit the reservation confirmation information to the terminal device via the guide information providing unit.

### Application Example 1

### Supplementary 1

A system comprising a processor,
wherein the processor is configured to
provide, on an information processing apparatus, an interface for receiving input information including travel conditions from a user,
analyze the input information to normalize the travel conditions and, based on the travel conditions, generate a prompt sentence including at least items relating to a travel itinerary, a transportation resource, an accommodation resource, and a sightseeing location, and further including an output format specification, and control input of the prompt sentence to a generative AI model,
acquire text or structured data of a travel plan from the generative AI model, parse the text or the structured data, convert the parsed result into an internal data structure in which the itinerary is divided on a per-day basis or a time-slot basis, and, based on the internal data structure, generate digital tour pamphlet data in which the travel itinerary, the transportation resource, the accommodation resource, and the sightseeing location are hierarchically organized,
transmit the digital tour pamphlet data to a portable information terminal via a communication network, and cause the digital tour pamphlet data to be displayable by an application on the portable information terminal,
receive, from the portable information terminal, a bulk reservation request for a plurality of services included in a specified travel itinerary based on the digital tour pamphlet, and, based on the bulk reservation request, execute reservation processing for a plurality of external service providing apparatuses including a transportation providing apparatus and an accommodation providing apparatus sequentially or in parallel, and generate bulk reservation result information based on results of the reservation processing, and
transmit the bulk reservation result information to the portable information terminal and cause finalized contents of bulk reservations to be viewable on the portable information terminal.

### Supplementary 2

The system according to supplementary 1,
wherein the processor is configured to
receive, from the portable information terminal, a change request or preference information from the user with respect to the input information and the travel plan acquired from the generative AI model, generate, based on an update condition including the change request or the preference information, a new prompt sentence, input the new prompt sentence to the generative AI model to update the travel plan, and, based on the updated travel plan, regenerate the digital tour pamphlet data.

### Supplementary 3

The system according to supplementary 1,
wherein the processor is configured to
append, when generating the prompt sentence to be input to the generative AI model, the output format specification to the prompt sentence, the output format specification requesting that the travel itinerary be output in a structured manner on a per-day basis or a time-slot basis and that each activity included in the travel itinerary be output in a structured data format including at least an identifier, location information, and time-slot information, and use, in accordance with the output format specification, structured data acquired from the generative AI model for generation of the digital tour pamphlet data.

### Example 2

### Supplementary 1

A system comprising a processor,
wherein the processor is configured to
receive travel condition information as input information from a terminal,
analyze the travel condition information and generate a prompt sentence for instructing generation of a travel plan that satisfies the travel condition information,
input the prompt sentence to a generative artificial intelligence model and obtain a travel plan proposal expressed in natural language from the generative artificial intelligence model, analyze the travel plan proposal and generate structured travel plan data by extracting elements relating to travel schedule, movement means, stay facility, and visit place, obtain movement route information and movement cost by using an external connection function for route information acquisition provided by a route information providing apparatus based on the structured travel plan data, obtain stay facility information and stay cost by using an external connection function for stay facility information acquisition provided by a stay facility reservation apparatus based on the structured travel plan data, and obtain visit place information and required fee by using an external connection function for visit place information acquisition provided by a sightseeing information providing apparatus based on the structured travel plan data,
calculate, based on the obtained movement route information, stay facility information, and visit place information, a sequence of activities and times for each day so as to satisfy movement time, opening time, admission time, stay facility check-in and check-out time, and budget constraints, and adjust the structured travel plan data to generate a realistic travel plan, generate a digital information medium including the adjusted travel plan in a machine-readable format and in a human-readable format, and transmit the digital information medium to the terminal, and
receive, from the terminal, a reservation request for collectively reserving the movement means, the stay facility, and the visit place included in the digital information medium, and execute a collective reservation process by transmitting reservation information to the route information providing apparatus, the stay facility reservation apparatus, and the sightseeing information providing apparatus based on the reservation request.

### Supplementary 2

The system according to supplementary 1,
wherein the processor is configured to
generate the digital information medium in an electronic brochure format in which activities, movement means, stay facilities, and visit places for each travel day are visually separated for display, and to provide the digital information medium to the terminal as data suitable for display by the terminal.

### Supplementary 3

The system according to supplementary 1,
wherein the processor is configured to
in the collective reservation process, acquire success or failure information for each reservation, generate an additional prompt sentence for the generative artificial intelligence model in accordance with the failure information to search for alternative movement means, stay facilities, or visit places, update the travel plan to include an alternative element, and transmit reservation information again based on the updated travel plan.

### Application Example 2

### Supplementary 1

A system comprising a processor,
wherein the processor is configured to
acquire condition information and preference information from a user via a terminal, and convert the acquired information into structured data and, based on the structured data, extract candidate service information, and
analyze input information or emotion-related data acquired from an emotion acquisition device so as to estimate an emotional state of the user and generate emotion information representing the emotional state, and
generate a prompt sentence that instructs a generative AI model to generate at least one of a travel plan or a supply plan, based on the structured data and the emotion information, and
input the prompt sentence and the candidate service information into the generative AI model and obtain plan information including at least one of the travel plan or the supply plan from the generative AI model, and
analyze the plan information and, while verifying whether the plan information satisfies predetermined constraint conditions, generate integrated plan data including at least a schedule, a location, a cost, and a service content, and
generate digital guidance information including the integrated plan data and including schedule information, position information, description information, and an operation element for performing bulk reservation or bulk ordering, and
transmit the digital guidance information to the terminal and present the digital guidance information to the user, and
in response to a bulk reservation operation or a bulk ordering operation by the user on the digital guidance information, communicate with an external reservation device or an external ordering device and perform bulk reservation or bulk ordering for a plurality of services or a plurality of supplies.

### Supplementary 2

The system according to supplementary 1,
wherein the processor is configured to
generate display data by adding attribute information indicating at least one emotion attribute including relaxation, activity, or calmness, to at least one item among sightseeing spot information, accommodation information, dining facility information, and supply source information within the digital guidance information, based on the emotion information.

### Supplementary 3

The system according to supplementary 1,
wherein the processor is configured to
refer to a plurality of pieces of schedule information and a plurality of pieces of service information included in the integrated plan data, and, by using a communication function of the external reservation device or the external ordering device, sequentially execute, in response to a single operation by the user, reservation or ordering of at least one of transportation, accommodation, sightseeing facilities, dining facilities, and goods supply services, and return confirmation information obtained as a result of the reservation or the ordering to the terminal in association with the digital guidance information.

What is claimed is:

1. A system comprising:
circuitry configured to:
receive input data from a terminal apparatus via a packet-switched network, the input data including at least a target region identifier, an implementation period specification, and an upper expenditure limit value;
acquire reference data from a storage medium, the reference data including historical pattern data and trend information data;
construct a parameterized instruction sequence based on the input data and the reference data, the parameterized instruction sequence specifying a behavior plan generation task for a generative neural network model;
provide the parameterized instruction sequence to the generative neural network model to cause the generative neural network model to generate behavior plan data including activity element data, movement resource data, facility resource data, and cost information data conforming to the implementation period specification and the upper expenditure limit value; and
verify the behavior plan data by determining consistency of aggregate cost values with the upper expenditure limit value and temporal consistency of scheduled elements with the implementation period specification.

2. The system according to claim 1, wherein the circuitry is further configured to:
convert the verified behavior plan data into structured guide data for an electronic medium, the structured guide data including time-series scheduling information, position information, cost breakdown information, and visual configuration information organized hierarchically on a per-period or per-time-slot basis.

3. The system according to claim 2, wherein the structured guide data includes, for each period, a list of activity element entries, attribute information of associated facility resources, timing information of associated movement resources, and cost allocation values, together with layout specification data for visual presentation.

4. The system according to claim 3, wherein the circuitry is further configured to:
transmit the structured guide data to the terminal apparatus via the packet-switched network for display on a presentation interface of the terminal apparatus.

5. The system according to claim 4, wherein the circuitry is further configured to:
receive, from the terminal apparatus, a batch resource allocation request identifying a selected behavior plan from the structured guide data, and execute a plurality of resource allocation processes in batch regarding at least scheduling elements, movement resources, and facility resources by communicating with a plurality of external resource management apparatuses via the packet-switched network.

6. The system according to claim 5, wherein the circuitry is further configured to:
generate, based on the behavior plan data, request data for each external resource management apparatus corresponding to each activity element, each movement resource, and each facility resource, communicate with the plurality of external resource management apparatuses using the request data, integrate allocation results acquired from the plurality of external resource management apparatuses, and generate allocation confirmation data including allocation identification information and total cost information.

7. The system according to claim 6, wherein the circuitry is further configured to:
transmit the allocation confirmation data to the terminal apparatus for visual presentation, enabling the entity to review finalized allocation details.

8. The system according to claim 1, wherein the circuitry is further configured to:
analyze the input data by applying a natural language processing algorithm to extract entity preference data, constraint parameter data, and priority data from the input data, and normalize the extracted data into a structured format for incorporation into the parameterized instruction sequence.

9. The system according to claim 8, wherein the parameterized instruction sequence includes an output format specification requiring the generative neural network model to return the behavior plan data in a machine-readable structured format including hierarchically organized elements with identifier fields, attribute fields, temporal fields, and cost fields.

10. The system according to claim 9, wherein the circuitry is further configured to:
parse the behavior plan data generated by the generative neural network model by applying pattern recognition rules and delimiter detection to extract activity element entries, movement resource entries, and facility resource entries from a text output, and convert the extracted entries into an internal data structure.

11. The system according to claim 10, wherein the verification processing comprises calculating a sum of individual cost values for all entries in the internal data structure, comparing the sum against the upper expenditure limit value, verifying that temporal allocations for successive entries do not overlap, and flagging entries that violate cost or temporal constraints.

12. The system according to claim 1, wherein the generative neural network model comprises a transformer-based architecture including an embedding layer, a plurality of self-attention layers, feed-forward layers, and normalization layers, and wherein the circuitry provides the parameterized instruction sequence as a token sequence to the transformer-based architecture together with decoding control parameters including a maximum output token count and a sampling temperature value.

13. The system according to claim 12, wherein the circuitry is further configured to:
acquire availability data for movement resources and facility resources from external data sources via the packet-switched network, and incorporate the availability data into the parameterized instruction sequence to constrain the generative neural network model to generate behavior plan data referencing only currently available resources.

14. The system according to claim 13, wherein the circuitry is further configured to:
generate a plurality of alternative behavior plan data sets by providing the parameterized instruction sequence with variation parameters specifying different optimization priorities including cost minimization, time efficiency maximization, and activity diversity maximization, and present the plurality of alternative behavior plan data sets to the terminal apparatus for entity selection.

15. The system according to claim 1, wherein the circuitry is further configured to:
acquire image data from an imaging device and acoustic data from an acoustic transducer associated with the terminal apparatus, extract visual feature data and acoustic feature data, apply an emotion estimation model to a combined feature vector derived from the visual feature data and the acoustic feature data to compute emotion classification data, and adapt the parameterized instruction sequence based on the emotion classification data.

16. The system according to claim 15, wherein the emotion estimation model comprises a multi-layer neural network having an input layer, one or more hidden layers with non-linear activation functions, and an output layer that computes probability distributions over a set of emotion category labels.

17. The system according to claim 1, wherein the circuitry is further configured to:
receive feedback data from the terminal apparatus after completion of a behavior plan, associate the feedback data with the behavior plan data in the storage medium, and use the feedback data as additional reference data for subsequent parameterized instruction sequence construction to improve future behavior plan generation quality.

18. A system comprising:
circuitry configured to:
receive, via a communication interface coupled to a packet-switched network, input data from a terminal apparatus including a target region identifier, an implementation period specification, and an upper expenditure limit value;
acquire reference data including historical pattern data and trend information from a storage medium;
construct a parameterized instruction sequence based on the input data and the reference data, and provide the parameterized instruction sequence to a generative neural network model having a transformer-based architecture including a plurality of self-attention layers to generate behavior plan data including activity element data, movement resource data, facility resource data, and cost information data;
verify the behavior plan data against the upper expenditure limit value and the implementation period specification;
convert the verified behavior plan data into structured guide data for an electronic medium including time-series scheduling information and cost breakdown information; and
transmit the structured guide data to the terminal apparatus and, upon receiving a batch resource allocation request, execute resource allocation processes with external resource management apparatuses via the packet-switched network.

19. The system according to claim 18, wherein the circuitry is further configured to:
generate request data for each external resource management apparatus based on the behavior plan data, communicate with a plurality of external resource management apparatuses to execute the resource allocation processes, integrate allocation results, and transmit allocation confirmation data including allocation identification information and total cost information to the terminal apparatus.

20. A method performed by circuitry, the method comprising:
receiving input data from a terminal apparatus via a packet-switched network, the input data including at least a target region identifier, an implementation period specification, and an upper expenditure limit value;
acquiring reference data from a storage medium, the reference data including historical pattern data and trend information data;
constructing a parameterized instruction sequence based on the input data and the reference data, the parameterized instruction sequence specifying a behavior plan generation task for a generative neural network model;
providing the parameterized instruction sequence to the generative neural network model to cause the generative neural network model to generate behavior plan data including activity element data, movement resource data, facility resource data, and cost information data conforming to the implementation period specification and the upper expenditure limit value; and
verifying the behavior plan data by determining consistency of aggregate cost values with the upper expenditure limit value and temporal consistency of scheduled elements with the implementation period specification.
